(19) United States
(12) Patent Application Publication
(10) Pub. No.: US 2026/0073926 A1
(43) Pub. Date: Mar. 12, 2026

(54) ENCODING METHOD AND ELECTRONIC DEVICE

(71) Applicant: HUAWEI TECHNOLOGIES CO., LTD., Shenzhen (CN)

(72) Inventors: Juan Isaac Engel Alonso Martinez, Munich (DE); Dezhu Xu, Beijing (CN); Yuan Gao, Beijing (CN); Zhe Wang, Beijing (CN)

(73) Assignee: HUAWEI TECHNOLOGIES CO., LTD., Shenzhen (CN)

(21) Appl. No.: 19/384,387

(22) Filed: Nov. 10, 2025

Related U.S. Application Data
(63) Continuation of application No. PCT/CN2024/102910, filed on Jul. 1, 2024.

(30) Foreign Application Priority Data
Jul. 10, 2023 (CN) 202310843654.X

(51) Int. Cl. G10L 19/00; H04S 7/00

(52) U.S. Cl. CPC G10L 19/00; H04S 7/30; H04S 2400/11

(57) ABSTRACT

An encoding method and an electronic device are provided. The method includes obtaining a scene audio signal and metadata of the scene audio signal, where the metadata includes first metadata, the first metadata is used in combination with a distance between two of the plurality of microphones to determine a virtual loudspeaker radius, the virtual loudspeaker radius and a virtual loudspeaker signal are used for rendering to obtain a rendered audio signal, and the virtual loudspeaker signal is generated based on a reconstructed audio signal of the scene audio signal The method also includes encoding the scene audio signal and the metadata to obtain a bitstream.

### CROSS-REFERENCE TO RELATED APPLICATIONS

This application is a continuation of International Application No. PCT/CN2024/102910, filed on Jul. 1, 2024, which claims priority to Chinese Patent Application No. 202310843654.X, filed on Jul. 10, 2023. The disclosures of the aforementioned applications are hereby incorporated by reference in their entireties.

### TECHNICAL FIELD

Embodiments of this application relate to the encoding and decoding field, and in particular, to an encoding method and an electronic device.

### BACKGROUND

To meet immersive audio requirements for extended reality (XR) applications, the MPEG-I audio standard provides a multipoint higher-order ambisonics (HOA)-based 6-degree of freedom (DoF) audio technology. First, several sound sources and HOA microphones at a plurality of points are deployed in a room. Subsequently, the sound sources play audio signals, and the HOA microphones at the plurality of points capture sounds in the room to obtain HOA signals of the plurality of points. Then, a bitstream is obtained after the HOA signals of the plurality of points pass through an audio encoder. After decoding the bitstream, an audio decoder performs rendering based on information such as a signal obtained through decoding, HOA metadata, and a user position and posture, to obtain a binaural rendered signal.

### SUMMARY

In view of this, this application provides an encoding method and an electronic device. In the encoding method, an encoder side may write metadata of a scene audio signal into a bitstream. In this way, the metadata of the scene audio signal can be transmitted to a decoder side. Therefore, the decoder side does not need to obtain the metadata of the scene audio signal from another electronic device, and does not need to locally generate the metadata of the scene audio signal, so that time for obtaining a binaural rendered signal through rendering can be reduced, thereby improving user experience.

According to a first aspect, an embodiment of this application provides an encoding method. The method includes: first obtaining a scene audio signal and metadata of the scene audio signal, where the scene audio signal describes a sound field of a sound source in a scene, the scene includes a plurality of microphones, the metadata includes first metadata, the first metadata is used in combination with a distance between two of the plurality of microphones to determine a virtual loudspeaker radius, the virtual loudspeaker radius and a virtual loudspeaker signal are used for rendering to obtain a rendered audio signal, and the virtual loudspeaker signal is generated based on a reconstructed audio signal of the scene audio signal; and then encoding the scene audio signal and the metadata to obtain a bitstream. In this way, after the bitstream is transmitted to a decoder side, the decoder side may parse the bitstream to obtain the metadata of the scene audio signal, and apply the metadata of the scene audio signal to a subsequent process of obtaining the rendered audio signal through rendering. Further, the decoder side does not need to obtain the metadata of the scene audio signal from another electronic device, and does not need to locally generate the metadata of the scene audio signal, improving efficiency of obtaining the metadata of the scene audio signal by the decoder side, and reducing a calculation amount of generating the metadata of the scene audio signal. Therefore, time for obtaining the rendered audio signal through rendering can be reduced, thereby improving user experience.

For example, the rendered audio signal may be an audio signal that is output to a play module (for example, a headset) for playing, and may be a binaural rendered signal.

For example, there is an equal distance between any two microphones in the plurality of microphones.

For example, the scene audio signal may include HOA signals of a plurality of points (where the HOA signals may include a three-dimensional HOA signal and a two-dimensional HOA signal (which may also be referred to as a planar HOA signal)) and a three-dimensional audio signal. The three-dimensional audio signal may be an audio signal other than the HOA signal in the scene audio signal. In this application, an example in which the scene audio signal is HOA signals of a plurality of points is used for description.

For example, the microphone may be an HOA microphone. Several sound sources and HOA microphones at a plurality of points may be first deployed in a room (that is, a real scene). Subsequently, the sound sources play audio signals, and the HOA microphones at the plurality of points capture sounds in the room to obtain HOA signals of the plurality of points.

For example, the scene audio signal may be an audio signal to be encoded on an encoder side, and the reconstructed audio signal of the scene audio signal is an audio signal obtained by a decoder side or a decoding module on the encoder side based on a bitstream obtained by encoding the scene audio signal. The reconstructed audio signal may also be referred to as a reconstructed scene audio signal.

It should be noted that a sequence of encoding the scene audio signal and encoding the metadata is not limited in this application.

According to the first aspect, the method further includes: writing a first identifier into the bitstream, where the first identifier indicates rendering complexity, and the rendering complexity is used to determine a number of virtual loudspeakers. In this way, the decoder side may perform rendering based on the number of virtual loudspeakers, the virtual loudspeaker radius, and the virtual loudspeaker signal, to obtain the rendered audio signal.

For example, audio quality of a binaural rendered signal obtained through rendering correspondingly varies with rendering complexity. A value of the first identifier may be user-defined, or may be determined based on a computing capability of the decoder side. In this way, the decoder side may obtain, through rendering, a binaural rendered signal whose audio quality matches factors such as a user requirement and a computing capability of an electronic device.

According to any one of the first aspect or the foregoing embodiments of the first aspect, a second identifier is written into the bitstream, where the second identifier indicates whether the bitstream includes the metadata of the scene audio signal.

There may be a plurality of renderers (each renderer uses a different rendering method) on the decoder side. The plurality of renderers include a renderer that performs rendering based on the metadata of the scene audio signal and a renderer that performs rendering based on other information. Further, the second identifier may further indicate whether to perform rendering based on the metadata of the scene audio signal. In this way, the decoder side may determine, based on a value of the second identifier obtained from the bitstream through parsing, which renderer or which rendering algorithm is to be used for rendering.

According to any one of the first aspect or the foregoing embodiments of the first aspect, the second identifier further indicates whether the bitstream further includes the first identifier.

The plurality of renderers included in the decoder side may include a renderer that performs rendering based on the metadata of the scene audio signal and the first identifier and a renderer that performs rendering based on other information. Further, the second identifier may further indicate whether to perform rendering based on the metadata of the scene audio signal and the first identifier. In this way, the decoder side may determine, based on a value of the second identifier obtained from the bitstream through parsing, which renderer or which rendering algorithm is to be used for rendering.

According to any one of the first aspect or the foregoing embodiments of the first aspect, the method further includes: writing a third identifier into the bitstream, where the third identifier indicates whether the bitstream includes the first identifier. In this case, the second identifier may indicate only whether the bitstream includes the metadata.

According to any one of the first aspect or the foregoing embodiments of the first aspect, obtaining the metadata of the scene audio signal includes: obtaining scene description information of the scene; and determining the metadata based on the scene description information of the scene. In this way, a binaural rendered signal obtained through rendering based on the metadata of the scene audio signal is closer to a real audio signal heard in a real environment in which a user is located.

For example, the scene description information may be information for describing the scene, and for example, may include but is not limited to: identifiers, position information, features, directions, and the like of HOA microphones at a plurality of points in a real scene; coordinates, a material, and the like of an object included in the real scene; an identifier, position information, a feature, a direction, and the like of a sound source in the real scene; a room critical distance in the real scene; an acoustic reverberation parameter (for example, a direct-to-reverberation energy ratio (DRR), reverberation time (such as T20 (time of 20-dB energy attenuation), T30, or T60), and clarity (such as C50 (a ratio of sound energy within 50 ms to sound energy after 50 ms) or C80)); and the like. This is not limited in this application.

For example, the room critical distance may mean a distance from a point at which a direct sound energy density is equal to a reverberation sound energy density to a center of a sound source in a specific direction when the sound source stably radiates a sound wave indoors (in a real environment), and is also referred to as a diffusion field distance. When radiation directivity of the sound source is spherical, critical distances in all directions are equal, and are also referred to as a reverberation radius in this case.

According to any one of the first aspect or the foregoing embodiments of the first aspect, determining the metadata based on the scene description information of the scene includes: when the scene description information includes the room critical distance of the scene, determining the first metadata based on a product of the room critical distance and a preset value.

According to any one of the first aspect or the foregoing embodiments of the first aspect, determining the metadata based on the scene description information of the scene includes: when the scene description information includes the acoustic reverberation parameter of the scene, determining a reverberation type of the scene based on the acoustic reverberation parameter of the scene; and determining the first metadata based on the reverberation type of the scene.

There may be a plurality of reverberation types, and different reverberation types correspond to different first metadata. For example, first metadata corresponding to a first reverberation type (corresponding to a dry sound scene or a non-reverberant room) is 0.5, and first metadata corresponding to a second reverberation type (corresponding to a wet sound scene or a reverberant room) is 1.5.

According to any one of the first aspect or the foregoing embodiments of the first aspect, the metadata further includes second metadata, and determining the metadata based on the scene description information of the scene includes: when the scene description information includes position information of the plurality of microphones, using the position information of the plurality of microphones as the second metadata, where the second metadata is used to determine the distance between two of the plurality of microphones.

According to any one of the first aspect or the foregoing embodiments of the first aspect, the metadata further includes second metadata, and determining the metadata based on the scene description information of the scene includes: when the scene description information includes position information of the plurality of microphones, determining the distance between two of the plurality of microphones based on the position information of the plurality of microphones; and using the distance between two of the plurality of microphones as the second metadata.

According to any one of the first aspect or the foregoing embodiments of the first aspect, obtaining the metadata of the scene audio signal includes: obtaining the metadata that is of the scene audio signal and that is input by the user. In other words, the user may customize the metadata of the scene audio signal, so that a binaural rendered signal subsequently obtained by the decoder side through rendering can match a personalized requirement of the user.

According to any one of the first aspect or the foregoing embodiments of the first aspect, the bitstream includes a syntax element of the metadata of the scene audio signal and corresponding description information.

For example, the syntax element of the metadata of the scene audio signal and the corresponding description information may be added to an original syntax structure (or referred to as a high-level syntax element table) of the bitstream. In this way, the encoder side may write the metadata of the scene audio signal into the bitstream based on the syntax element of the metadata of the scene audio signal and the corresponding description information in the syntax structure of the bitstream.

According to any one of the first aspect or the foregoing embodiments of the first aspect, the bitstream includes a syntax element of the first identifier and corresponding description information.

For example, the syntax element of the first identifier and the corresponding description information may be added to the original syntax structure of the bitstream. In this way, the encoder side may write the first identifier into the bitstream based on the syntax element of the first identifier and the corresponding description information in the syntax structure of the bitstream.

According to any one of the first aspect or the foregoing embodiments of the first aspect, the bitstream includes a syntax element of the second identifier and corresponding description information.

For example, the syntax element of the second identifier and the corresponding description information may be added to the original syntax structure of the bitstream. In this way, the encoder side may write the second identifier into the bitstream based on the syntax element of the second identifier and the corresponding description information in the syntax structure of the bitstream.

According to any one of the first aspect or the foregoing embodiments of the first aspect, the bitstream includes a syntax element of the third identifier and corresponding description information.

According to any one of the first aspect or the foregoing embodiments of the first aspect, the scene audio signal includes higher-order ambisonics HOA signals of a plurality of points.

According to any one of the first aspect or the foregoing embodiments of the first aspect, a syntax element of the first metadata is distanceFactor.

According to any one of the first aspect or the foregoing embodiments of the first aspect, the syntax element of the first identifier is complexityLevel.

According to any one of the first aspect or the foregoing embodiments of the first aspect, the syntax element of the second identifier is hoaGroupHasLowProfileConfig.

According to a second aspect, an embodiment of this application provides a decoding method. The method includes: receiving a bitstream; parsing the bitstream to obtain metadata of a scene audio signal; and obtaining a reconstructed audio signal of the scene audio signal based on the bitstream, where the scene audio signal describes a sound field of a sound source in a scene, the scene includes a plurality of microphones, the metadata includes first metadata, the first metadata is used in combination with a distance between two of the plurality of microphones to determine a virtual loudspeaker radius, the virtual loudspeaker radius and a virtual loudspeaker signal are used for rendering to obtain a rendered audio signal, and the virtual loudspeaker signal is generated based on the reconstructed audio signal. In this way, a decoder side does not need to obtain the metadata of the scene audio signal from another electronic device, and does not need to locally generate the metadata of the scene audio signal, improving efficiency of obtaining the metadata of the scene audio signal, and reducing a calculation amount of generating the metadata of the scene audio signal. Therefore, time for obtaining a binaural rendered signal through rendering can be reduced, thereby improving user experience.

According to the second aspect, the method further includes: parsing the bitstream to obtain a first identifier, where the first identifier indicates rendering complexity, and the rendering complexity is used to determine a number of virtual loudspeakers.

According to any one of the second aspect or the foregoing embodiments of the second aspect, the method further includes: parsing the bitstream to obtain a second identifier, where a value of the second identifier being a first preset identifier value indicates that the bitstream includes the metadata. In other words, when the value of the second identifier is the first preset identifier value, it may be determined that the decoder side performs rendering based on the metadata of the scene audio signal, and it is determined that the bitstream includes the metadata of the scene audio signal. Further, the bitstream may continue to be parsed to obtain the metadata of the scene audio signal.

According to any one of the second aspect or the foregoing embodiments of the second aspect, the value of the second identifier being the first preset identifier value indicates that the bitstream further includes the first identifier. In other words, when the value of the second identifier is the first preset identifier value, it may be determined that the decoder side performs rendering based on the metadata of the scene audio signal and the first identifier, and it may be further determined that the bitstream further includes the first identifier. Further, the bitstream may continue to be parsed to obtain the first identifier.

According to any one of the second aspect or the foregoing embodiments of the second aspect, the method further includes: parsing the bitstream to obtain a third identifier, where a value of the third identifier being a second preset identifier value indicates that the bitstream includes the first identifier.

According to any one of the second aspect or the foregoing embodiments of the second aspect, the metadata further includes second metadata, and the second metadata is used to determine the distance between two of the plurality of microphones.

According to any one of the second aspect or the foregoing embodiments of the second aspect, the scene audio signal includes higher-order ambisonics HOA signals of a plurality of points, and the reconstructed audio signal includes reconstructed audio signals of the HOA signals of the plurality of points.

According to any one of the second aspect or the foregoing embodiments of the second aspect, the bitstream includes a syntax element of the metadata and corresponding description information; and parsing the bitstream to obtain the metadata of the scene audio signal includes: parsing the bitstream to obtain the metadata based on the syntax element of the metadata and the corresponding description information.

According to any one of the second aspect or the foregoing embodiments of the second aspect, the bitstream includes a syntax element of the first identifier and corresponding description information; and parsing the bitstream to obtain the first identifier includes: parsing the bitstream to obtain the first identifier based on the syntax element of the first identifier and the corresponding description information.

According to any one of the second aspect or the foregoing embodiments of the second aspect, the bitstream includes a syntax element of the second identifier and corresponding description information; and parsing the bitstream to obtain the second identifier includes: parsing the bitstream to obtain the second identifier based on the syntax element of the second identifier and the corresponding description information.

According to any one of the second aspect or the foregoing embodiments of the second aspect, the bitstream includes a syntax element of the third identifier and corresponding description information; and parsing the bitstream to obtain the third identifier includes: parsing the bitstream to obtain the third identifier based on the syntax element of the third identifier and the corresponding description information.

According to any one of the second aspect or the foregoing embodiments of the second aspect, a syntax element of the first metadata is distanceFactor.

According to any one of the second aspect or the foregoing embodiments of the second aspect, the syntax element of the first identifier is complexityLevel.

According to any one of the second aspect or the foregoing embodiments of the second aspect, the syntax element of the second identifier is hoaGroupHasLowProfileConfig.

According to any one of the second aspect or the foregoing embodiments of the second aspect, the method further includes: generating the virtual loudspeaker signal based on the reconstructed audio signal of the scene audio signal; determining the virtual loudspeaker radius based on the first metadata and the distance between two of the plurality of microphones; and performing rendering based on the virtual loudspeaker radius and the virtual loudspeaker signal, to obtain the rendered audio signal.

The second aspect and any embodiment of the second aspect are respectively corresponding to the first aspect and any embodiment of the first aspect. For technical effects corresponding to the second aspect and any embodiment of the second aspect, refer to the technical effects corresponding to the first aspect and any embodiment of the first aspect. Details are not described herein again.

According to a third aspect, an embodiment of this application provides an encoding method. The method includes: first obtaining a scene audio signal; and then encoding the scene audio signal and a first identifier to obtain a bitstream, where the first identifier indicates rendering complexity, the rendering complexity is used to determine a number of virtual loudspeakers, a reconstructed audio signal of the scene audio signal is used to generate a virtual loudspeaker signal, and the virtual loudspeaker signal and the number of virtual loudspeakers are used for rendering to obtain a rendered audio signal.

In this way, a decoder side may perform rendering based on the number of virtual loudspeakers, a virtual loudspeaker radius, and the virtual loudspeaker signal, to obtain the rendered audio signal. For example, audio quality of a binaural rendered signal obtained through rendering correspondingly varies with rendering complexity. A value of the first identifier may be user-defined, or may be determined based on a computing capability of the decoder side. In this way, the decoder side may obtain, through rendering, a binaural rendered signal whose audio quality matches factors such as a user requirement and a computing capability of an electronic device.

According to the third aspect, the method further includes: writing a second identifier into the bitstream, where the second identifier indicates whether the bitstream includes the first identifier.

According to any one of the third aspect or the foregoing embodiments of the third aspect, the bitstream includes a syntax element of the first identifier and corresponding description information.

According to any one of the third aspect or the foregoing embodiments of the third aspect, the bitstream includes a syntax element of the second identifier and corresponding description information.

According to any one of the third aspect or the foregoing embodiments of the third aspect, the scene audio signal includes higher-order ambisonics HOA signals of a plurality of points.

According to any one of the third aspect or the foregoing embodiments of the third aspect, the syntax element of the first identifier is complexityLevel.

The third aspect and any embodiment of the third aspect are respectively corresponding to the first aspect and any embodiment of the first aspect. For technical effects corresponding to the third aspect and any embodiment of the third aspect, refer to the technical effects corresponding to the first aspect and any embodiment of the first aspect. Details are not described herein again.

According to a fourth aspect, an embodiment of this application further provides a decoding method. The method includes: receiving a bitstream; parsing the bitstream to obtain a first identifier; and obtaining a reconstructed audio signal based on the bitstream, where the first identifier indicates rendering complexity, the rendering complexity is used to determine a number of virtual loudspeakers, the reconstructed audio signal is used to generate a virtual loudspeaker signal, and the virtual loudspeaker signal and the number of virtual loudspeakers are used for rendering to obtain a rendered audio signal.

According to the fourth aspect, the method further includes: parsing the bitstream to obtain a second identifier, where a value of the second identifier being a preset identifier value indicates that the bitstream includes the first identifier.

According to any one of the fourth aspect or the foregoing embodiments of the fourth aspect, the bitstream includes a syntax element of the first identifier and corresponding description information; and parsing the bitstream to obtain the first identifier includes: parsing the bitstream to obtain the first identifier based on the syntax element of the first identifier and the corresponding description information.

According to any one of the fourth aspect or the foregoing embodiments of the fourth aspect, the bitstream includes a syntax element of the second identifier and corresponding description information; and parsing the bitstream to obtain the second identifier includes: parsing the bitstream to obtain the second identifier based on the syntax element of the second identifier and the corresponding description information.

According to any one of the fourth aspect or the foregoing embodiments of the fourth aspect, the reconstructed audio signal includes reconstructed audio signals of higher-order ambisonics (HOA) signals of a plurality of points.

According to any one of the fourth aspect or the foregoing embodiments of the fourth aspect, the syntax element of the first identifier is complexityLevel.

According to any one of the fourth aspect or the foregoing embodiments of the fourth aspect, the method further includes: generating the virtual loudspeaker signal based on the reconstructed audio signal of a scene audio signal; determining the number of virtual loudspeakers based on the first identifier; and performing rendering based on the number of virtual loudspeakers and the virtual loudspeaker signal, to obtain the rendered audio signal.

The fourth aspect and any embodiment of the fourth aspect are respectively corresponding to the first aspect and any embodiment of the first aspect. For technical effects corresponding to the fourth aspect and any embodiment of the fourth aspect, refer to the technical effects corresponding to the first aspect and any embodiment of the first aspect. Details are not described herein again.

According to a fifth aspect, an embodiment of this application provides an encoding apparatus. The encoding apparatus includes:
a first data obtaining module, configured to obtain a scene audio signal and metadata of the scene audio signal, where the scene audio signal describes a sound field of a sound source in a scene, the scene includes a plurality of microphones, the metadata includes first metadata, the first metadata is used in combination with a distance between two of the plurality of microphones to determine a virtual loudspeaker radius, the virtual loudspeaker radius and a virtual loudspeaker signal are used for rendering to obtain a rendered audio signal, and the virtual loudspeaker signal is generated based on a reconstructed audio signal of the scene audio signal; and
a first encoding module, configured to encode the scene audio signal and the metadata to obtain a bitstream.

In addition, the encoding apparatus may further include a communication module.

It should be understood that the encoding apparatus may further perform the first aspect and any embodiment of the first aspect. For corresponding effects, refer to the technical effects corresponding to the first aspect and any embodiment of the first aspect. Details are not described herein again.

According to a sixth aspect, an embodiment of this application provides a decoding apparatus. The decoding apparatus includes:
a first receiving module, configured to receive a bitstream;
a first parsing module, configured to parse the bitstream to obtain metadata of a scene audio signal; and
a first signal obtaining module, configured to obtain a reconstructed audio signal of the scene audio signal based on the bitstream, where the scene audio signal describes a sound field of a sound source in a scene, the scene includes a plurality of microphones, the metadata includes first metadata, the first metadata is used in combination with a distance between two of the plurality of microphones to determine a virtual loudspeaker radius, the virtual loudspeaker radius and a virtual loudspeaker signal are used for rendering to obtain a rendered audio signal, and the virtual loudspeaker signal is generated based on the reconstructed audio signal.

In addition, the decoding apparatus may further include a communication module.

It should be understood that the decoding apparatus may further perform the second aspect and any embodiment of the second aspect. For corresponding effects, refer to the technical effects corresponding to the second aspect and any embodiment of the second aspect. Details are not described herein again.

According to a seventh aspect, an embodiment of this application provides an encoding apparatus. The encoding apparatus includes:
a second data obtaining module, configured to obtain a scene audio signal; and
a second encoding module, configured to encode the scene audio signal and a first identifier to obtain a bitstream, where the first identifier indicates rendering complexity, the rendering complexity is used to determine a number of virtual loudspeakers, a reconstructed audio signal of the scene audio signal is used to generate a virtual loudspeaker signal, and the virtual loudspeaker signal and the number of virtual loudspeakers are used for rendering to obtain a rendered audio signal.

In addition, the encoding apparatus may further include a communication module.

It should be understood that the encoding apparatus may further perform the third aspect and any embodiment of the third aspect. For corresponding effects, refer to the technical effects corresponding to the third aspect and any embodiment of the third aspect. Details are not described herein again.

According to an eighth aspect, an embodiment of this application provides a decoding apparatus. The decoding apparatus includes:
a second receiving module, configured to receive a bitstream;
a second parsing module, configured to parse the bitstream to obtain a first identifier; and
a second signal obtaining module, configured to obtain a reconstructed audio signal of a scene audio signal based on the bitstream, where the first identifier indicates rendering complexity, the rendering complexity is used to determine a number of virtual loudspeakers, the reconstructed audio signal is used to generate a virtual loudspeaker signal, and the virtual loudspeaker signal and the number of virtual loudspeakers are used for rendering to obtain a rendered audio signal.

In addition, the decoding apparatus may further include a communication module.

It should be understood that the decoding apparatus may further perform the fourth aspect and any embodiment of the fourth aspect. For corresponding effects, refer to the technical effects corresponding to the fourth aspect and any embodiment of the fourth aspect. Details are not described herein again.

According to a ninth aspect, an embodiment of this application provides an electronic device, including a memory and a processor. The memory is coupled to the processor. The memory stores program instructions. When the program instructions are executed by the processor, the electronic device is enabled to perform the encoding method according to the first aspect or any possible embodiment of the first aspect, or the electronic device is enabled to perform the encoding method according to the third aspect or any possible embodiment of the third aspect.

The ninth aspect and any embodiment of the ninth aspect are respectively corresponding to the first aspect and any embodiment of the first aspect, or are respectively corresponding to the third aspect and any embodiment of the third aspect. For technical effects corresponding to the ninth aspect and any embodiment of the ninth aspect, refer to the technical effects corresponding to the first aspect and any embodiment of the first aspect, or refer to the technical effects corresponding to the third aspect and any embodiment of the third aspect. Details are not described herein again.

According to a tenth aspect, an embodiment of this application provides an electronic device, including a memory and a processor. The memory is coupled to the processor. The memory stores program instructions. When the program instructions are executed by the processor, the electronic device is enabled to perform the decoding method according to the second aspect or any possible embodiment of the second aspect, or the electronic device is enabled to perform the decoding method according to the fourth aspect or any possible embodiment of the fourth aspect.

The tenth aspect and any embodiment of the tenth aspect are respectively corresponding to the second aspect and any embodiment of the second aspect, or are respectively corresponding to the fourth aspect and any embodiment of the fourth aspect. For technical effects corresponding to the tenth aspect and any embodiment of the tenth aspect, refer to the technical effects corresponding to the second aspect and any embodiment of the second aspect, or refer to the technical effects corresponding to the fourth aspect and any embodiment of the fourth aspect. Details are not described herein again.

According to an eleventh aspect, an embodiment of this application provides a chip, including one or more interface circuits and one or more processors. The one or more processors receive or send data through the one or more interface circuits, and when the one or more processors execute computer instructions, the method according to the first aspect or any possible embodiment of the first aspect is performed, or the method according to the third aspect or any possible embodiment of the third aspect is performed.

The eleventh aspect and any embodiment of the eleventh aspect are respectively corresponding to the first aspect and any embodiment of the first aspect, or are respectively corresponding to the third aspect and any embodiment of the third aspect. For technical effects corresponding to the eleventh aspect and any embodiment of the eleventh aspect, refer to the technical effects corresponding to the first aspect and any embodiment of the first aspect, or refer to the technical effects corresponding to the third aspect and any embodiment of the third aspect. Details are not described herein again.

According to a twelfth aspect, an embodiment of this application provides a chip, including one or more interface circuits and one or more processors. The one or more processors receive or send data through the one or more interface circuits, and when the one or more processors execute computer instructions, the method according to the second aspect or any possible embodiment of the second aspect is performed, or the method according to the fourth aspect or any possible embodiment of the fourth aspect is performed.

The twelfth aspect and any embodiment of the twelfth aspect are respectively corresponding to the second aspect and any embodiment of the second aspect, or are respectively corresponding to the fourth aspect and any embodiment of the fourth aspect. For technical effects corresponding to the twelfth aspect and any embodiment of the twelfth aspect, refer to the technical effects corresponding to the second aspect and any embodiment of the second aspect, or refer to the technical effects corresponding to the fourth aspect and any embodiment of the fourth aspect. Details are not described herein again.

According to a thirteenth aspect, an embodiment of this application provides a computer-readable storage medium. The computer-readable storage medium stores a computer program. When the computer program is run on a computer or a processor, the computer or the processor is enabled to perform the encoding method according to the first aspect or any possible embodiment of the first aspect, or the computer or the processor is enabled to perform the encoding method according to the third aspect or any possible embodiment of the third aspect.

The thirteenth aspect and any embodiment of the thirteenth aspect are respectively corresponding to the first aspect and any embodiment of the first aspect, or are respectively corresponding to the third aspect and any embodiment of the third aspect. For technical effects corresponding to the thirteenth aspect and any embodiment of the thirteenth aspect, refer to the technical effects corresponding to the first aspect and any embodiment of the first aspect, or refer to the technical effects corresponding to the third aspect and any embodiment of the third aspect. Details are not described herein again.

According to a fourteenth aspect, an embodiment of this application provides a computer-readable storage medium. The computer-readable storage medium stores a computer program. When the computer program is run on a computer or a processor, the computer or the processor is enabled to perform the decoding method according to the second aspect or any possible embodiment of the second aspect, or the computer or the processor is enabled to perform the decoding method according to the fourth aspect or any possible embodiment of the fourth aspect.

The fourteenth aspect and any embodiment of the fourteenth aspect are respectively corresponding to the second aspect and any embodiment of the second aspect, or are respectively corresponding to the fourth aspect and any embodiment of the fourth aspect. For technical effects corresponding to the fourteenth aspect and any embodiment of the fourteenth aspect, refer to the technical effects corresponding to the second aspect and any embodiment of the second aspect, or refer to the technical effects corresponding to the fourth aspect and any embodiment of the fourth aspect. Details are not described herein again.

According to a fifteenth aspect, an embodiment of this application provides a computer program product. The computer program product includes computer instructions. When the computer instructions are executed by a computer or a processor, the computer or the processor is enabled to perform the encoding method according to the first aspect or any possible embodiment of the first aspect, or the computer or the processor is enabled to perform the encoding method according to the third aspect or any possible embodiment of the third aspect.

The fifteenth aspect and any embodiment of the fifteenth aspect are respectively corresponding to the first aspect and any embodiment of the first aspect, or are respectively corresponding to the third aspect and any embodiment of the third aspect. For technical effects corresponding to the fifteenth aspect and any embodiment of the fifteenth aspect, refer to the technical effects corresponding to the first aspect and any embodiment of the first aspect, or refer to the technical effects corresponding to the third aspect and any embodiment of the third aspect. Details are not described herein again.

According to a sixteenth aspect, an embodiment of this application provides a computer program product. The computer program product includes computer instructions. When the computer instructions are executed by a computer or a processor, the computer or the processor is enabled to perform the decoding method according to the second aspect or any possible embodiment of the second aspect, or the computer or the processor is enabled to perform the decoding method according to the fourth aspect or any possible embodiment of the fourth aspect.

The sixteenth aspect and any embodiment of the sixteenth aspect are respectively corresponding to the second aspect and any embodiment of the second aspect, or are respectively corresponding to the fourth aspect and any embodiment of the fourth aspect. For technical effects corresponding to the sixteenth aspect and any embodiment of the sixteenth aspect, refer to the technical effects corresponding to the second aspect and any embodiment of the second aspect, or refer to the technical effects corresponding to the fourth aspect and any embodiment of the fourth aspect. Details are not described herein again.

According to a seventeenth aspect, an embodiment of this application further provides an XR device. The XR device includes a processor and an audio play module.

The processor is configured to perform the operations in the second aspect and any embodiment of the second aspect.

The audio play module is configured to play the rendered audio signal in the second aspect and any embodiment of the second aspect.

The seventeenth aspect and any embodiment of the seventeenth aspect are respectively corresponding to the second aspect and any embodiment of the second aspect. For technical effects corresponding to the seventeenth aspect and any embodiment of the seventeenth aspect, refer to the technical effects corresponding to the second aspect and any embodiment of the second aspect. Details are not described herein again.

According to an eighteenth aspect, an embodiment of this application further provides an XR device. The XR device includes a processor and an audio play module.

The processor is configured to perform the operations in the fourth aspect and any embodiment of the fourth aspect.

The audio play module is configured to play the rendered audio signal in the fourth aspect and any embodiment of the fourth aspect.

The eighteenth aspect and any embodiment of the eighteenth aspect are respectively corresponding to the fourth aspect and any embodiment of the fourth aspect. For technical effects corresponding to the eighteenth aspect and any embodiment of the eighteenth aspect, refer to the technical effects corresponding to the fourth aspect and any embodiment of the fourth aspect. Details are not described herein again.

### BRIEF DESCRIPTION OF DRAWINGS

FIG. 1A is a diagram of an example application scenario;

FIG. 1B is a diagram of an example application scenario;

FIG. 1C is a diagram of an example application scenario;

FIG. 1D is a diagram of an example application scenario;

FIG. 2A is a diagram of an example compression framework of a scene audio signal;

FIG. 2B is a diagram of an example transcoding framework of a scene audio signal;

FIG. 2C is a diagram of an example rendering process;

FIG. 2D is a diagram of an example scene;

FIG. 2E is a diagram of an example scene;

FIG. 3A is a diagram of an example encoding process;

FIG. 3B is a diagram of an example bitstream structure;

FIG. 4A is a diagram of an example decoding process;

FIG. 4B is a diagram of an example process of generating a binaural rendered signal;

FIG. 5A is a diagram of an example encoding process;

FIG. 5B is a diagram of an example bitstream structure;

FIG. 6A is a diagram of an example decoding process;

FIG. 6B is a diagram of an example process of generating a binaural rendered signal;

FIG. 7A is a diagram of an example encoding process;

FIG. 7B is a diagram of an example bitstream structure;

FIG. 8 is a diagram of an example decoding process;

FIG. 9A is a diagram of an example encoding process;

FIG. 9B is a diagram of an example bitstream structure;

FIG. 10 is a diagram of an example decoding process;

FIG. 11 is a diagram of an example encoding process;

FIG. 12 is a diagram of an example decoding process;

FIG. 13 is a diagram of an example process of generating a binaural rendered signal;

FIG. 14 is a diagram of an example encoding apparatus;

FIG. 15 is a diagram of an example decoding apparatus;

FIG. 16 is a diagram of an example encoding apparatus;

FIG. 17 is a diagram of an example decoding apparatus; and

FIG. 18 is a diagram of an example structure of an apparatus.

### DESCRIPTION OF EMBODIMENTS

The following clearly and completely describes the technical solutions in embodiments of this application with reference to the accompanying drawings in embodiments of this application. It is clear that the described embodiments are some rather than all of embodiments of this application. All other embodiments obtained by a person of ordinary skill in the art based on embodiments of this application without creative efforts shall fall within the protection scope of this application.

The term “and/or” in this specification is merely an association relationship of associated objects, and indicates that three relationships may exist. For example, A and/or B may indicate the following three cases: Only A exists, both A and B exist, and only B exists.

The terms “first” and “second” in the specification and claims of embodiments of this application are used to distinguish between different objects, but are not used to describe a specific sequence of objects. For example, a first target object and a second target object are used to distinguish between different target objects, but are not used to describe a specific sequence of the target objects.

In embodiments of this application, words such as “example” or “for example” are used to represent giving examples, illustrations, or descriptions. Any embodiment or design solution described as “example” or “for example” in embodiments of this application should not be construed as being more preferred or advantageous than other embodiments or design solutions. Specifically, the words such as “example” or “for example” are used to present related concepts in a specific manner.

In descriptions of embodiments of this application, unless otherwise stated, “a plurality of” means two or more. For example, a plurality of processing units refer to two or more processing units, and a plurality of systems refer to two or more systems.

For clear and brief description of the following embodiments, brief descriptions of related technologies are first provided.

A sound is a continuous wave generated by vibration of an object. The object that vibrates and emits the sound wave is referred to as a sound source. In a process in which the sound wave is propagated through a medium (for example, air, solid, or liquid), an auditory organ of a human or an animal can sense the sound.

Features of the sound wave include a tone, intensity, and a timbre. The tone indicates a level of the sound. The intensity indicates volume of the sound. The intensity may also be referred to as loudness or volume. A unit of the intensity is decibel (dB). The timbre is also referred to as sound quality.

A frequency of the sound wave determines the level of the tone. A higher frequency indicates a higher tone. A quantity of vibration times of the object within 1 second is referred to as the frequency. A unit of the frequency is hertz (Hz). A frequency of a sound that can be recognized by a human ear is between 20 Hz and 20000 Hz.

An amplitude of the sound wave determines the intensity. A larger amplitude indicates higher intensity. A shorter distance from the sound source indicates higher intensity.

A waveform of the sound wave determines the timbre. Waveforms of sound waves include a square wave, a sawtooth wave, a sine wave, a pulse wave, and the like.

Based on features of sound waves, sounds may be classified into a regular sound and an irregular sound. The irregular sound is a sound emitted by a sound source that vibrates irregularly. The irregular sound is, for example, noise that affects people's work, study, rest, and the like. The regular sound is a sound emitted by a sound source that vibrates regularly. Regular sounds include a voice and a music sound. When a sound is represented electrically, the regular sound is an analog signal that changes continuously in time-frequency domain. The analog signal may be referred to as an audio signal. The audio signal is an information carrier that carries a voice, music, and sound effects.

Because human's auditory sense has a capability of distinguishing position distribution of a sound source in space, when hearing a sound in space, a listener can sense a direction and a position of the sound in addition to a tone, intensity, and a timbre of the sound.

As people pay increasing attention to auditory system experience and have increasingly high requirements for quality, a three-dimensional audio technology emerges, to enhance a sense of depth, a sense of immersion, and a sense of space of a sound. In this way, a listener not only feels sounds produced by front, rear, left, and right sound sources, but also feels that space in which the listener is located is surrounded by a spatial sound field (sound field for short) produced by the sound sources, and feels that the sound spreads around. This creates “immersive” sound effect that enables the listener to feel like being in a place such as a movie theater or a concert hall.

It is well known that when a sound wave is propagated in an ideal medium, a wave number is k=w/c, and an angular frequency is w=2πf, where f is a sound wave frequency, and C is a sound velocity. Sound pressure P satisfies Formula (1), and ∇² is a Laplace operator.

$${∇}^{2} p + {k}^{2} p = 0 \qquad ( 1 )$$

It is assumed that a spatial system outside a human ear is a sphere, and a listener is at a center of the sphere. A sound transmitted from the outside of the sphere has a projection on a spherical surface, and a sound outside the spherical surface is filtered out. It is assumed that a sound source is distributed on the spherical surface, and a sound field produced by the sound source on the spherical surface fits a sound field produced by an original sound source. That is, the three-dimensional audio technology is a sound field fitting method. Specifically, the equation in Formula (1) is solved in a spherical coordinate system. In a passive spherical area, a solution to the equation in Formula (1) is the following Formula (2):

$$p ( r , θ , φ , k ) = s {\sum }_{m = 0}^{∞} ( 2 m + 1 ) {j}^{m} {j}_{m}^{kr} ( kr ) {\sum }_{0 \leq n \leq m , σ \pm 1} {Y}_{m , n}^{σ} ( {θ}_{s} , {φ}_{s} ) {Y}_{m , n}^{σ} ( θ , φ ) \qquad ( 2 )$$

r represents a radius of the sphere, θ represents horizontal angle information (or referred to as azimuth information), φ represents elevation angle information (or referred to as elevation information), k represents a wave number, s represents an amplitude of an ideal plane wave, and m represents an order serial number of an HOA signal (or is referred to as an order serial number of an HOA signal).

$${j}^{m} {j}_{m}^{kr} ( kr )$$

represents a spherical Bessel function, and the spherical Bessel function is also referred to as a radial basis function, where the first j represents an imaginary unit, and

$$( 2 m + 1 ) {j}^{m} {j}_{m}^{kr} ( kr )$$

does not change with an angle.

$${Y}_{m , n}^{σ} ( θ , φ )$$

represents a spherical harmonic function in a θ, φ direction, and

$${Y}_{m , n}^{σ} ( {θ}_{s} , {φ}_{s} )$$

represents a spherical harmonic function in a direction of a sound source. The HOA signal satisfies Formula (3).

$${B}_{m , n}^{σ} = s \cdot {Y}_{m , n}^{σ} ( {θ}_{s} , {φ}_{s} ) \qquad ( 3 )$$

Formula (3) is substituted into Formula (2), and Formula (2) may be transformed into Formula (4).

$$p ( r , θ , φ , k ) = {\sum }_{m = 0}^{∞} {j}^{m} {j}_{m}^{kr} ( kr ) {\sum }_{0 \leq n \leq m , σ \pm 1} {B}_{m , n}^{σ} {Y}_{m , n}^{σ} ( θ , φ ) \qquad ( 4 )$$

m is truncated to an N^{th} item, that is, m=N, and

$${B}_{m , n}^{σ}$$

is used as an approximate description for a sound field. In this case,

$${B}_{m , n}^{σ}$$

may be referred to as an HOA coefficient (which may represent an N^{th}-order HOA signal). The sound field is an area in which a sound wave exists in a medium. N is an integer greater than or equal to 1, and the N^{th}-order HOA signal includes an audio signal of (N+1)² channels.

Formula (4) indicates that the sound field may be expanded on a spherical surface based on a spherical harmonic function. In other words, the sound field may be decomposed into superposition of a plurality of plane waves. Therefore, the sound field described by the HOA signal may be expressed by using superposition of a plurality of plane waves, and the sound field is reconstructed by using the HOA coefficient.

A scene audio signal in embodiments of this application is an information carrier that carries spatial position information of a sound source in a sound field, and describes a sound field of a listener in space, or may be a signal for describing a sound field of a sound source. The scene audio signal may include HOA signals of a plurality of points (where the HOA signals may include a three-dimensional HOA signal and a two-dimensional HOA signal (which may also be referred to as a planar HOA signal)) and a three-dimensional audio signal. The three-dimensional audio signal may be an audio signal other than the HOA signal in the scene audio signal. In this application, an example in which the scene audio signal is HOA signals of a plurality of points is used for description.

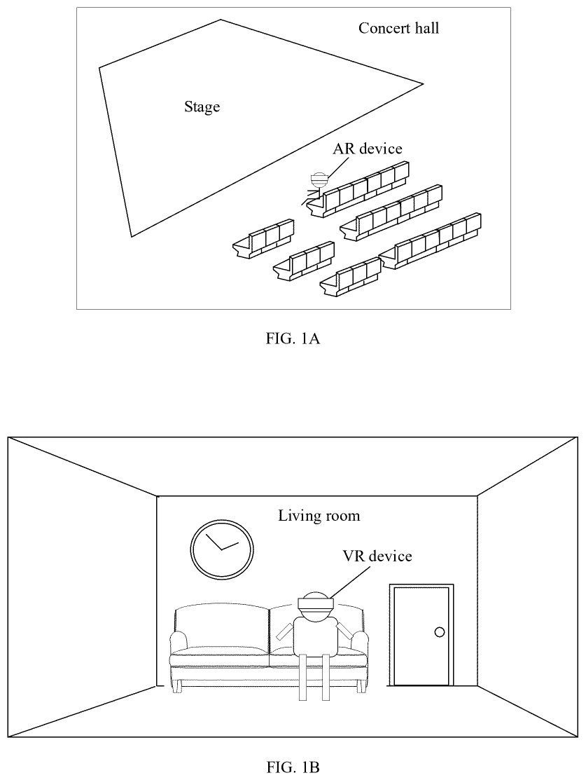

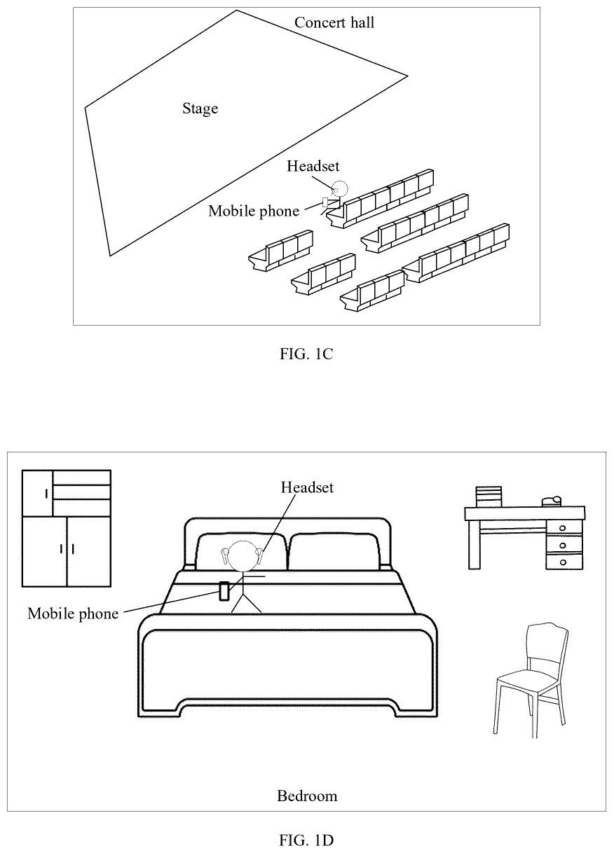

FIG. 1A is a diagram of an example application scenario. FIG. 1A shows an application scenario in which a user uses an augmented reality (AR) device to experience an AR concert. It should be understood that the user may further use the AR device to explore another AR experience such as an AR science lecture hall or an AR movie theater. This is not limited in this application.

In FIG. 1A, a real scene in which the user is located and a virtual scene corresponding to the AR experience explored by the user are a same scene, that is, the real scene in which the user is located is a concert hall, and the virtual scene corresponding to the AR experience explored by the user is a virtual concert hall.

Refer to FIG. 1A. For example, when the user expects to experience an AR concert in a vacant concert hall, the user may wear the AR device; and then, the user may select an AR concert hall in the AR device as an AR experience that the user expects to explore, select a music file that the user expects to experience, and perform a play operation. Subsequently, the AR device may process, for example, render, the music file selected by the user, to obtain a rendered audio signal (which may be, for example, a spatial audio signal (that is, a binaural rendered signal), where an example in which the rendered audio signal is a binaural rendered signal is used for description in this application), and play the binaural rendered signal through a headset. In addition, the AR device may further display a play picture on a display, so that the user can see, on the display, that a player plays at a corresponding position on a stage of the concert hall. In this way, the user can experience the concert in an immersive manner through combination of vision and hearing.

FIG. 1B is a diagram of an example application scenario. FIG. 1B shows an application scenario in which a user uses a virtual reality (VR) device to explore a VR movie theater. It should be understood that the user may further use the VR device to explore another VR experience such as a VR concert hall or a VR science lecture hall. This is not limited in this application.

In FIG. 1B, a real scene in which the user is located and a virtual scene corresponding to the VR experience explored by the user are not a same scene, that is, the real scene in which the user is located is a living room, and the virtual scene corresponding to the VR experience explored by the user is a virtual movie theater.

Refer to FIG. 1B. For example, when the user expects to experience a VR movie theater in the living room, the user may wear the VR device; and then, the user may select a VR movie theater in the VR device as a VR experience that the user expects to explore, select a movie file that the user expects to experience, and perform a play operation. Subsequently, the VR device may process, for example, render, an audio file included in the movie file, to obtain a binaural rendered signal, and play the binaural rendered signal through a headset. In addition, the VR device may further display a movie picture on a display. In this way, the user can experience the movie in an immersive manner through combination of vision and hearing.

FIG. 1C is a diagram of an example application scenario. FIG. 1C shows an application scenario in which a user uses (a mobile phone+a headset) to experience a concert.

It should be understood that the user may further use (the mobile phone+the headset) to explore another listening experience such as a cross talk or a movie. This is not limited in this application. In addition, the mobile phone is merely an example in this application. In this application, a terminal device such as a tablet computer, a notebook computer, a personal computer, or a smartwatch and a headset may be alternatively used to experience listening.

In FIG. 1C, a real scene in which the user is located and a virtual scene corresponding to the listening experience explored by the user are a same scene, that is, the real scene in which the user is located is a concert hall, and the virtual scene corresponding to the listening experience explored by the user is a virtual concert hall.

Refer to FIG. 1C. For example, when the user expects to experience a concert in a vacant concert hall, the user may wear the headset and connect the headset to the mobile phone; and then, the user may select a concert in the mobile phone as a listening experience that the user expects to explore, select a music file that the user expects to experience, and perform a play operation. Subsequently, the mobile phone may process, for example, render, the music file selected by the user, to obtain a binaural rendered signal; and then, may send the binaural rendered signal to the headset for playing. In addition, the mobile phone may further play a concert play video. In this way, the user can experience the concert in the concert hall in an immersive manner by using the mobile phone.

FIG. 1D is a diagram of an example application scenario. FIG. 1D shows an application scenario in which a user uses (a mobile phone+a headset) to experience a cross talk.

It should be understood that the user may further use (the mobile phone+the headset) to explore another listening experience such as a concert or a movie. This is not limited in this application. In addition, the mobile phone is merely an example in this application. In this application, a terminal device such as a tablet computer, a notebook computer, a personal computer, or a smartwatch and a headset may be alternatively used to experience listening.

In FIG. 1D, a real scene in which the user is located and a virtual scene corresponding to the listening experience explored by the user are not a same scene, that is, the real scene in which the user is located is a living room, and the virtual scene corresponding to the listening experience explored by the user is a virtual studio.

Refer to FIG. 1D. For example, when the user expects to experience a cross talk in the living room, the user may wear the headset and connect the headset to the mobile phone; and then, the user may select a cross talk in the mobile phone as a listening experience that the user expects to explore, select a cross talk file that the user expects to experience, and perform a play operation. Subsequently, the mobile phone may process, for example, render, the cross talk file selected by the user, to obtain a binaural rendered signal; and then, may send the binaural rendered signal to the headset for playing. In addition, the mobile phone may further play a cross talk video. In this way, the user can experience the cross talk in the living room in an immersive manner by using the mobile phone.

For ease of description, the terminal device in FIG. 1A to FIG. 1D is referred to as a first electronic device.

In FIG. 1A to FIG. 1D, a music file of music, an audio file included in a movie file, and a cross talk file that are in the first electronic device (which may also be referred to as a decoder side) are all obtained from a second electronic device (which may also be referred to as an encoder side), and are encoded scene audio signals, that is, bitstreams. Further, the first electronic device needs to decode the bitstream to obtain a reconstructed audio signal, and then render the reconstructed audio signal to obtain a binaural rendered signal.

For example, several sound sources and HOA microphones at a plurality of points may be first deployed in a room (that is, a real scene). Subsequently, the sound sources play audio signals, and the HOA microphones at the plurality of points capture sounds in the room to obtain HOA signals of the plurality of points. In this case, the HOA signals of the plurality of points may describe a sound field of the sound source in the real scene. There is an equal distance between any two HOA microphones in the HOA microphones at the plurality of points. In this way, the second electronic device may obtain the HOA signals of the plurality of points from the HOA microphones at the plurality of points; and then, encode the HOA signals of the plurality of points to obtain a bitstream, and send the bitstream to the first electronic device.

In addition, for the scene in FIG. 1A and the scene in FIG. 1B, the second electronic device may further perform modeling based on the real scene to obtain a virtual scene. Then, the second electronic device may encode the virtual scene to obtain a bitstream, and send the bitstream to the first electronic device. It should be understood that a third electronic device may alternatively perform modeling, and send, to the first electronic device or the second electronic device, a bitstream obtained by encoding the virtual scene.

The real scene is an objectively existing scene, for example, a movie theater, a concert hall, or a lecture hall. The virtual scene is a scene constructed by using a virtual technology, and is not an objectively existing scene, for example, a virtual movie theater, a virtual concert hall, or a virtual lecture hall.

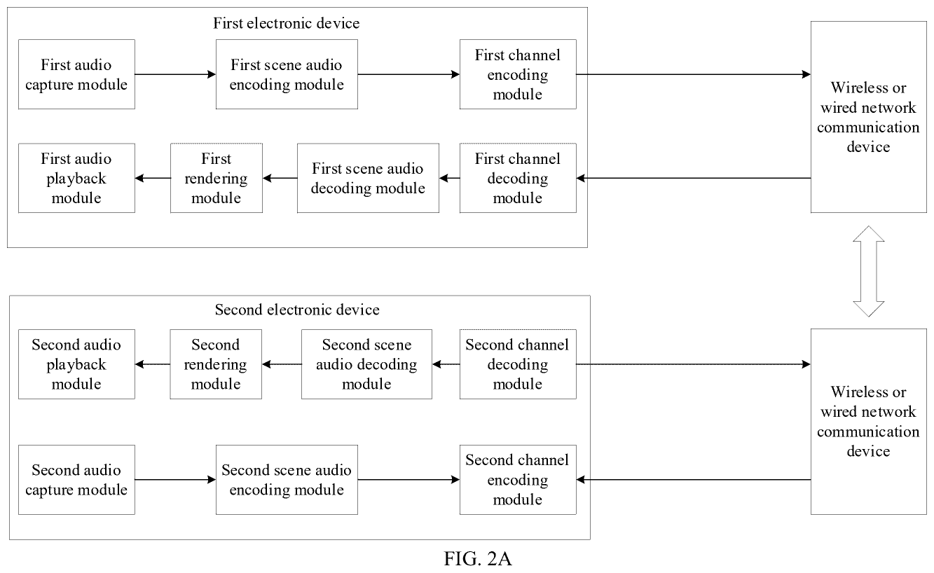

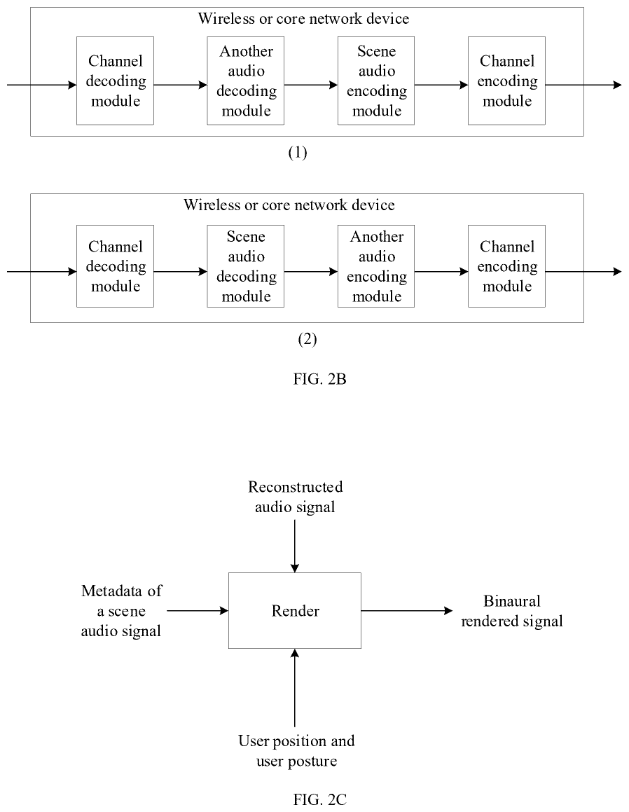

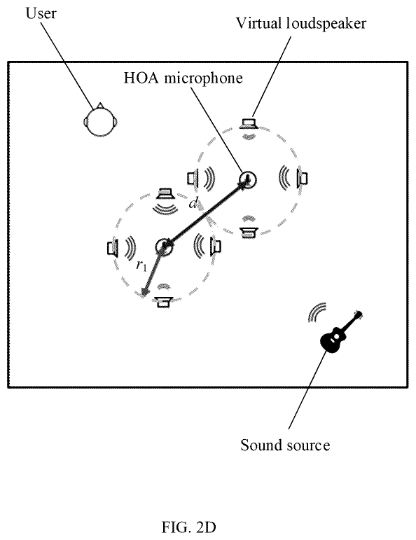

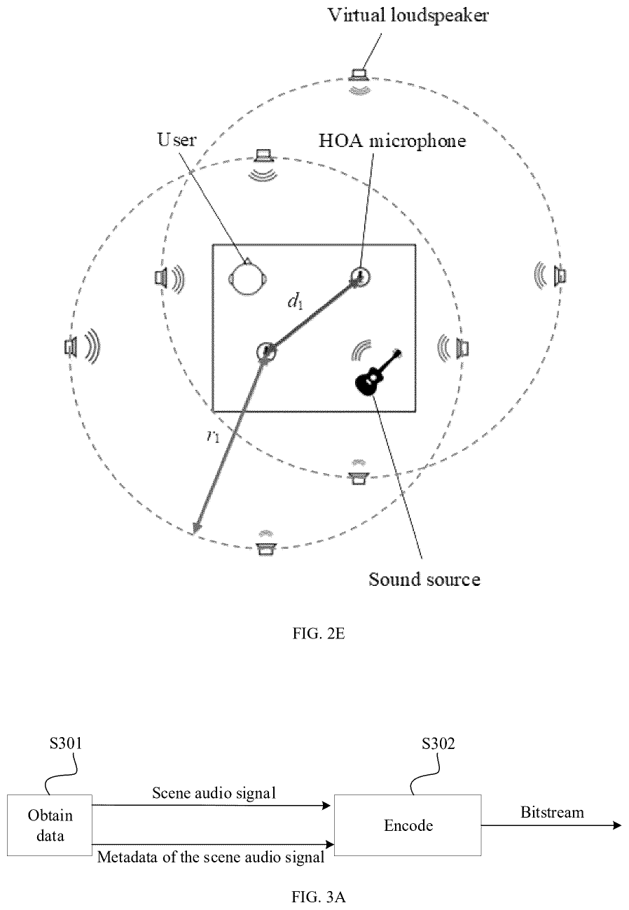

FIG. 2A is a diagram of an example compression framework of a scene audio signal.

Refer to FIG. 2A. For example, a first electronic device may include a first audio capture module, a first scene audio encoding module, a first channel encoding module, a first channel decoding module, a first scene audio decoding module, a first rendering module, and a first audio playback module. It should be understood that the first electronic device may include more or fewer modules than those shown in FIG. 2A. This is not limited in this application. The first rendering module may also be referred to as a first renderer, the first scene audio encoding module may also be referred to as a first audio encoder, and the first scene audio decoding module may also be referred to as a first audio decoder.

Refer to FIG. 2A. For example, a second electronic device may include a second audio capture module, a second scene audio encoding module, a second channel encoding module, a second channel decoding module, a second scene audio decoding module, a second rendering module, and a second audio playback module. It should be understood that the second electronic device may include more or fewer modules than those shown in FIG. 2A. This is not limited in this application. The second rendering module may also be referred to as a second renderer, the second scene audio encoding module may also be referred to as a second audio encoder, and the second scene audio decoding module may also be referred to as a second audio decoder.

For example, a process in which the first electronic device encodes a scene audio signal and transmits the scene audio signal to the second electronic device and the second electronic device performs decoding and audio playback may be as follows: The first audio capture module (for example, an HOA microphone connected to the first electronic device) may capture audio, and output the scene audio signal to the first scene audio encoding module. Subsequently, the first scene audio encoding module may encode the scene audio signal, and output a bitstream to the first channel encoding module. Then, the first channel encoding module may perform channel encoding on the bitstream, and transmit, to the second electronic device through a wireless or wired network communication device, a bitstream obtained through channel encoding. Then, the second channel decoding module of the second electronic device may perform channel decoding on received data to obtain a bitstream, and output the bitstream to the second scene audio decoding module. Subsequently, the second scene audio decoding module may decode the bitstream to obtain a reconstructed audio signal; and then output the reconstructed audio signal to the second rendering module. The second rendering module renders the reconstructed scene signal to obtain a binaural rendered signal; and then sends the binaural rendered signal to the second audio playback module. The second audio playback module performs audio playback.

It should be understood that a process in which the second electronic device encodes a scene audio signal and transmits the scene audio signal to the first electronic device and the first electronic device performs decoding and audio playback is similar to the foregoing process in which the first electronic device transmits the scene audio signal to the second electronic device and the second electronic device performs audio playback. Details are not described herein again.

For example, the first electronic device and the second electronic device each may include but are not limited to a personal computer, a computer workstation, a smartphone, a tablet computer, a server, a smart camera, an intelligent vehicle, another type of cellular phone, a media consumption device, a wearable device, a set-top box, a game console, and the like.

For example, this application may be specifically applied to a VR/AR scene. In a possible manner, the first electronic device is a server, and the second electronic device is a VR/AR device. In a possible manner, the second electronic device is a server, and the first electronic device is a VR/AR device.

It should be noted that, when the first electronic device and the second electronic device are VR/AR devices, the first audio playback module and the second audio playback module may be built-in headsets of the VR/AR devices; or when the first electronic device and the second electronic device are terminal devices other than VR/AR devices, the first audio playback module and the second audio playback module may be headsets externally connected to the other terminal devices.

For example, when the first electronic device encodes a scene audio signal and the second electronic device obtains a reconstructed audio signal through decoding, the first electronic device may be referred to as an encoder side, and the second electronic device may be referred to as a decoder side. When the second electronic device encodes a scene audio signal and the first electronic device obtains a reconstructed audio signal through decoding, the second electronic device may be referred to as an encoder side, and the first electronic device may be referred to as a decoder side.

FIG. 2B is a diagram of an example transcoding framework of a scene audio signal.

Refer to FIG. 2B(1). For example, a wireless or core network device may include a channel decoding module, another audio decoding module, a scene audio encoding module, and a channel encoding module. The wireless or core network device may be configured to perform audio transcoding.

For example, a specific application scenario in FIG. 2B(1) may be as follows: When a first electronic device is not provided with a scene audio encoding module and is provided with only another audio encoding module, and a second electronic device is provided with only a scene audio decoding module and is not provided with another audio decoding module, the wireless or core network device may be used for transcoding, so that the second electronic device can decode and play back a scene audio signal encoded by the first electronic device by using the another audio encoding module.

Specifically, the first electronic device encodes the scene audio signal by using the another audio encoding module to obtain a first bitstream, and sends the first bitstream to the wireless or core network device after performing channel encoding on the first bitstream. Subsequently, the channel decoding module of the wireless or core network device may perform channel decoding, and output, to the another audio decoding module, the first bitstream obtained through channel decoding. Then, the another audio decoding module decodes the first bitstream to obtain the scene audio signal, and outputs the scene audio signal to the scene audio encoding module. Then, the scene audio encoding module may encode the scene audio signal to obtain a second bitstream, and output the second bitstream to the channel encoding module. The channel encoding module sends the second bitstream to the second electronic device after performing channel encoding on the second bitstream. In this way, the second electronic device may invoke the scene audio decoding module to decode the second bitstream obtained through channel decoding, to obtain a reconstructed audio signal; and subsequently, may play back the reconstructed audio signal.

Refer to FIG. 2B(2). For example, a wireless or core network device may include a channel decoding module, a scene audio decoding module, another audio encoding module, and a channel encoding module. The wireless or core network device may be configured to perform audio transcoding.

For example, a specific application scenario in FIG. 2B(2) may be as follows: When a first electronic device is provided with only a scene audio encoding module and is not provided with another audio encoding module, and a second electronic device is not provided with a scene audio decoding module and is provided with only another audio decoding module, the wireless or core network device may be used for transcoding, so that the second electronic device can decode and play back a scene audio signal encoded by the first electronic device by using the scene audio encoding module.

Specifically, the first electronic device encodes the scene audio signal by using the scene audio encoding module to obtain a first bitstream, and sends the first bitstream to the wireless or core network device after performing channel encoding on the first bitstream. Subsequently, the channel decoding module of the wireless or core network device may perform channel decoding, and output, to the scene audio decoding module, the first bitstream obtained through channel decoding. Then, the scene audio decoding module decodes the first bitstream to obtain the scene audio signal, and outputs the scene audio signal to the another audio encoding module. Then, the another audio encoding module may encode the scene audio signal to obtain a second bitstream, and output the second bitstream to the channel encoding module. The channel encoding module sends the second bitstream to the second electronic device after performing channel encoding on the second bitstream. In this way, the second electronic device may invoke the another audio decoding module to decode the second bitstream obtained through channel decoding, to obtain a reconstructed audio signal; and subsequently, may play back the reconstructed audio signal.

Based on FIG. 2A and FIG. 2B, a process of obtaining a binaural rendered signal through rendering is described.

FIG. 2C is a diagram of an example rendering process. FIG. 2C is a diagram of a rendering process of a renderer (which may be a first renderer or a second renderer).

Refer to FIG. 2C. After obtaining a reconstructed audio signal based on a bitstream, a decoder side may input the reconstructed audio signal, metadata of a scene audio signal, a user position, and a user posture to the renderer. The renderer renders the reconstructed audio signal based on the metadata of the scene audio signal, the user position, and the user posture, to obtain a binaural rendered signal. The user posture may be a user head posture.

For example, when the decoder side is an AR/VR device, a sensor in the AR/VR device may obtain the user position and the user posture. When the decoder side is another terminal device, a positioning module in the decoder side may obtain the user position, and a headset connected to the decoder side obtains the user posture.

For example, the renderer may perform rendering by using a virtual loudspeaker object (VLO) algorithm, to obtain the binaural rendered signal. Specifically, the reconstructed audio signal may be first converted into a virtual loudspeaker signal. For details, refer to the following Formula (5):

$$S = DX \qquad ( 5 )$$

$$X = {[ {x}_{1} , … , {x}_{L} ]}^{T} , L = {( N + 1 )}^{2} \qquad ( 6 )$$

$$S = {[ {s}_{1} , … , {s}_{L} ]}^{T} , L = {( N + 1 )}^{2} \qquad ( 7 )$$

In Formula (5), S is the virtual loudspeaker signal, and an expression manner thereof is shown in Formula (7), where N is greater than 0. In other words, the reconstructed audio signal is converted into virtual loudspeaker signals of L virtual loudspeakers. In Formula (5), X is the reconstructed audio signal (that is, a reconstructed audio signal of an HOA signal), and an expression manner thereof is shown in Formula (6). In Formula (5), D is a decoding matrix whose size is L*L.

Subsequently, the virtual loudspeaker signal may be rendered based on the metadata of the scene audio signal, the user position, and the user posture, to obtain the binaural rendered signal. The metadata of the scene audio signal may include first metadata and second metadata. For a process of generating the binaural rendered signal, refer to the following S11 to S16.
S11: Determine, from the virtual loudspeaker signals of the L virtual loudspeakers, Y virtual loudspeaker signals Sn . . . Sm that are closest to the user position.

Y=m−n.
S12: Determine a distance d1 between HOA microphones at two points based on the second metadata.

In a possible manner, the second metadata is position information of HOA microphones at a plurality of points in a scene. In this case, a distance d1 between HOA microphones at any two points may be calculated based on the position information of the HOA microphones at the plurality of points in the scene.

In a possible manner, the second metadata is the distance d1 between the HOA microphones at any two points in the HOA microphones at the plurality of points.

FIG. 2D is a diagram of an example scene.

For example, FIG. 2D shows HOA microphones at two points in the scene, and Y=4. In other words, an HOA signal of one point (that is, an audio signal of a sound source (guitar) received by an HOA microphone at the one point) may be represented by using virtual loudspeaker signals of four virtual loudspeakers. The distance d1 between the HOA microphones at two points is shown in FIG. 2D.
S13: Determine a virtual loudspeaker radius r1 based on the first metadata and the distance d1 between the HOA microphones at two points.

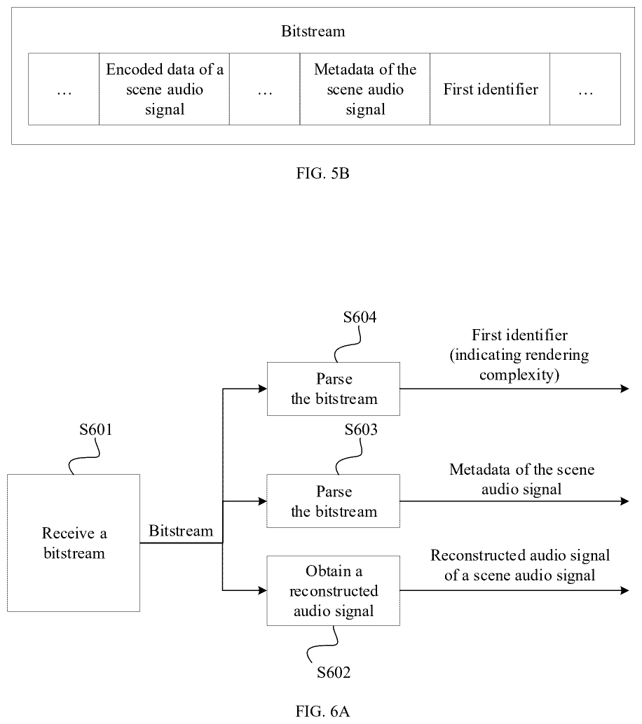

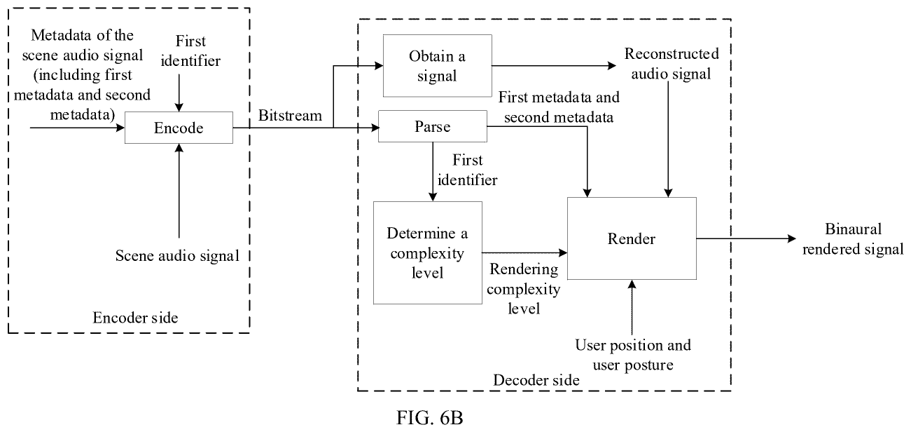

For example, the virtual loudspeaker radius r1 may be shown in FIG. 6B, and a calculation formula of the virtual loudspeaker radius r1 may be shown as the following Formula (8):

$$r = kd \qquad ( 8 )$$

In Formula (8), k represents the first metadata. In other words, when k is unchanged, larger d indicates larger r.

FIG. 2E is a diagram of an example scene. For FIG. 2E, refer to the descriptions of FIG. 2D. Details are not described herein again. A difference between FIG. 2E and FIG. 2D lies in the distance d1 between the HOA microphones at two points. The distance d1 between the HOA microphones at two points in FIG. 2E is greater than the distance d1 between the HOA microphones at two points in FIG. 2D. Correspondingly, the virtual loudspeaker radius r1 is larger in FIG. 2E.

S14: Select, from a head-related impulse response (Head-Related Impulse Response, HRIR) library based on the user posture and the virtual loudspeaker radius r1, head-related impulse responses HRIRn . . . HRIRm corresponding to the virtual loudspeaker signals Sn . . . Sm.

Sn corresponds to HRIRn, Sn+1 corresponds to HRIRn+1, . . . , and by analogy, Sm corresponds to HRIRm.
S15: Perform calculation based on Sn . . . Sm and corresponding HRIRn . . . HRIRm to obtain a binaural rendered signal of each of Y virtual loudspeakers.
S16: Add binaural rendered signals of all of the Y virtual loudspeakers to obtain the binaural rendered signal.

Refer to FIG. 2D or FIG. 2E. Binaural rendered signals of two virtual loudspeakers are added to obtain a binaural rendered signal at the user position.

In embodiments of this application, an encoder side may obtain metadata of a scene audio signal and write the metadata into a bitstream. In this way, a decoder side may parse the bitstream to obtain the metadata of the scene audio signal, and apply the metadata of the scene audio signal to a subsequent process of obtaining a binaural rendered signal through rendering. For a process of obtaining the metadata of the scene audio signal and a process of encoding and decoding, refer to the following embodiments.

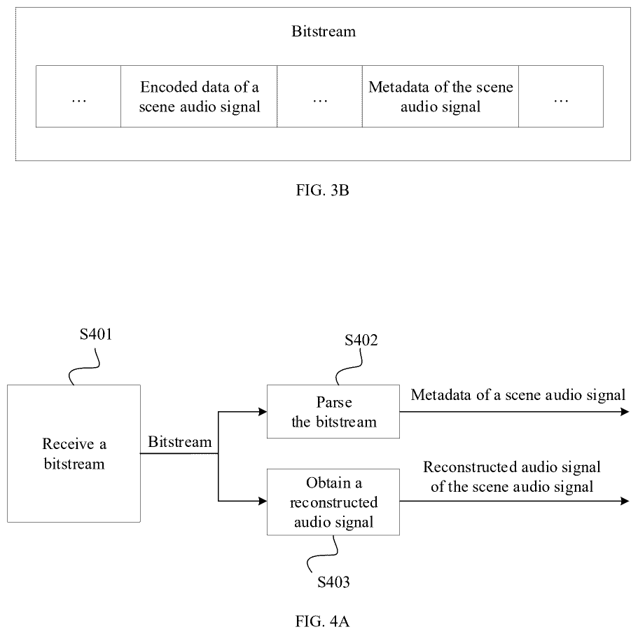

FIG. 3A is a diagram of an example encoding process.
S301: Obtain a scene audio signal and metadata of the scene audio signal.

For example, an encoder side may obtain HOA signals of a plurality of points from HOA microphones at the plurality of points as the scene audio signal.

For example, in this application, the metadata of the scene audio signal includes related information about the scene audio signal, and the metadata of the scene audio signal is applied to a process of obtaining a binaural rendered signal through rendering.

For example, in a possible manner of S301, an encoder may obtain scene description information of a scene, and then determine the metadata of the scene audio signal based on the scene description information of the scene. A specific process is described subsequently.

For example, the scene description information may be information for describing the scene, and for example, may include but is not limited to: identifiers, position information, features, directions, and the like of HOA microphones at a plurality of points in a real scene; coordinates, a material, and the like of an object included in the real scene; an identifier, position information, a feature, a direction, and the like of a sound source in the real scene; a room critical distance in the real scene (the room critical distance means a distance from a point at which a direct sound energy density is equal to a reverberation sound energy density to a center of a sound source in a specific direction when the sound source stably radiates a sound wave indoors (in the real scene), and is also referred to as a diffusion field distance; and when radiation directivity of the sound source is spherical, critical distances in all directions are equal, and are also referred to as a reverberation radius in this case); an acoustic reverberation parameter (for example, a direct-to-reverberation energy ratio (DRR), reverberation time (such as T20 (time of 20-dB energy attenuation), T30, or T60), and clarity (such as C50 (a ratio of sound energy within 50 ms to sound energy after 50 ms) or C80)); and the like. This is not limited in this application.

For example, in a possible manner of S301, the metadata that is of the scene audio signal and that is input by a user may be obtained, that is, the metadata of the scene audio signal may be user-defined.

In the embodiment in FIG. 3A, the obtained metadata of the scene audio signal includes only first metadata. The first metadata may be used in combination with a distance between two of a plurality of microphones to determine a virtual loudspeaker radius, and the microphones may be HOA microphones.
S302: Encode the scene audio signal and the metadata of the scene audio signal to obtain a bitstream.

A process of encoding the scene audio signal may be as follows:

In a first possible encoding scheme, the scene audio signal may be directly encoded to obtain encoded data of the scene audio signal, and the encoded data is written into the bitstream.

In a second possible encoding scheme, a target virtual loudspeaker may be first selected from a preset virtual loudspeaker set based on a first scene audio signal; subsequently, a first virtual loudspeaker signal is generated based on the first scene audio signal and attribute information of the target virtual loudspeaker; then, a second scene audio signal is determined by using the attribute information of the target virtual loudspeaker and the first virtual loudspeaker signal; subsequently, a residual signal is generated based on the first scene audio signal and the second scene audio signal; and then, the first virtual loudspeaker signal and the residual signal are encoded to obtain encoded data of the scene audio signal, and the encoded data is written into the bitstream. The first scene audio signal is an original to-be-encoded scene audio signal.

In a third possible encoding scheme, attribute information of a target virtual loudspeaker may be determined based on the scene audio signal, where the scene audio signal includes an audio signal of L channels, and L is a positive integer; and a first audio signal in the scene audio signal and the attribute information of the target virtual loudspeaker are encoded to obtain encoded data of the scene audio signal, and the encoded data is written into the bitstream, where the first audio signal is an audio signal of G channels in the scene audio signal, and G is a positive integer less than or equal to L.

For example, in the embodiment in FIG. 3A, in this application, a syntax element of the metadata of the scene audio signal and corresponding description information may be added in advance to an original syntax structure (or referred to as a high-level syntax element table) of the bitstream. In this way, the encoder side may write the metadata of the scene audio signal into the bitstream based on the syntax element of the metadata of the scene audio signal and the corresponding description information in the syntax structure of the bitstream.

For example, the syntax structure of the bitstream may be shown in the following Table 1.

TABLE 1

| Syntax | No. of bits | Mnemonic |
|---|---|---|
| Syntax element 1 | | |
| { | | |
| Syntax element 2 | 1 | bslbf |
| Syntax element 3 | 3 | bslbf |
| ... | | |
| Syntax element n | 4 | uimsbf |
| } | | |
| ... | | |
| Syntax element n+h | | |
| distanceFactor | 8 | uimsbf |

Refer to Table 1. In Table 1, Syntax represents a syntax element, No. of bits represents a number of bits of data identified by the syntax element, and Mnemonic represents a remark or an explanation of the syntax element.

Refer to Table 1. For example, the syntax structure of the bitstream includes a plurality of syntax elements: a syntax element 1, a syntax element 2, a syntax element 3, . . . , a syntax element n, . . . , a syntax element n+h, and a newly added syntax element “distanceFactor” in this application, where “distanceFactor” is the syntax element of the metadata of the scene audio signal, and n and h are positive integers.

Still refer to Table 1. “1” in the fourth row in Table 1 indicates that data identified by the syntax element 2 in the bitstream is represented by using 1 bit, and “bslbf” in the fourth row in Table 1 indicates that the data identified by the syntax element 2 in the bitstream is a bit string, left bit first.

“3” in the fifth row in Table 1 indicates that data identified by the syntax element 3 in the bitstream is represented by using 3 bits, and “bslbf” in the fifth row in Table 1 indicates that the data identified by the syntax element 3 in the bitstream is a bit string, left bit first.

“4” in the seventh row in Table 1 indicates that data identified by the syntax element n in the bitstream is represented by using 4 bits, and “uimsbf” in the seventh row in Table 1 indicates that the data identified by the syntax element n in the bitstream is an unsigned integer, most significant bit first.

“8” in the last row in Table 1 indicates that the metadata of the scene audio signal in the bitstream may be represented by using 8 bits, and “uimsbf” in the last row in Table 1 indicates that the metadata of the scene audio signal in the bitstream is an unsigned integer, most significant bit first. It should be understood that Table 1 is merely an example of this application. The metadata of the scene audio signal may be alternatively represented by using another number of bits, for example, 16 bits. This is not limited in this application. Further, in addition to being represented by using “distanceFactor”, the syntax element of the metadata of the scene audio signal may be alternatively represented by using another character string. This is not limited in this application.

For example, if the syntax structure of the bitstream is shown in Table 1, in a process of performing S302, the metadata of the scene audio signal may be converted into an 8-bit binary number; and then the 8-bit binary number is written after data identified by the syntax element n+h in the bitstream.

For example, S301 and S302 may be performed by an encoder.

FIG. 3B is a diagram of an example bitstream structure. A bitstream structure of the bitstream in the embodiment in FIG. 3A may be shown in FIG. 3B, that is, the metadata of the scene audio signal is after the encoded data of the scene audio signal.

It should be understood that, in the bitstream in this application, the metadata of the scene audio signal may be alternatively before the encoded data of the scene audio signal. This is not limited in this application. In addition, the bitstream in this application may further include other data. This is not limited in this application.

It should be noted that, in the bitstream in this application, the metadata of the scene audio signal may be adjacent to or may not be adjacent to the encoded data of the scene audio signal. This is not limited in this application.

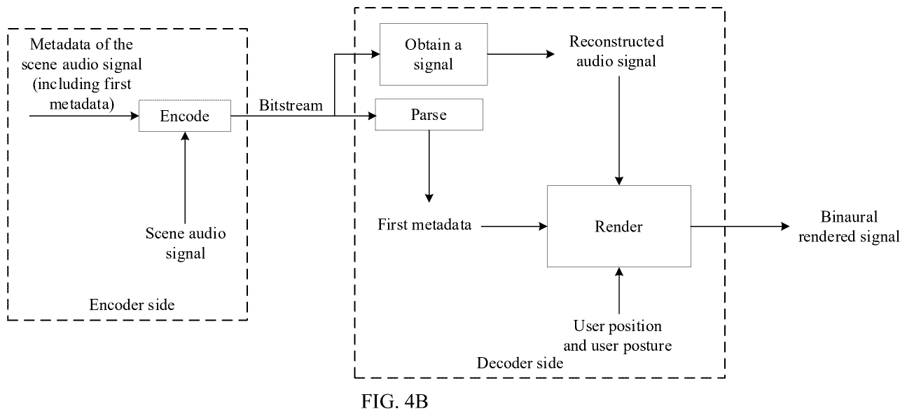

FIG. 4A is a diagram of an example decoding process. The decoding process in FIG. 4A corresponds to the encoding process in FIG. 3A.
S401: Receive a bitstream.
S402: Parse the bitstream to obtain metadata of a scene audio signal.
S403: Obtain a reconstructed audio signal of the scene audio signal based on the bitstream.

S401 and S402 are performed by a decoder. A sequence of performing S402 and S403 is not limited in this application.

For example, a process of obtaining the reconstructed audio signal of the scene audio signal based on the bitstream may be as follows:

In a first decoding scheme (corresponding to the foregoing first encoding scheme), the reconstructed audio signal of the scene audio signal may be directly decoded from the bitstream. In this case, S403 may be performed by the decoder.

In a second decoding scheme (corresponding to the foregoing second encoding scheme), a virtual loudspeaker signal and a residual signal may be decoded from the bitstream; and then, the reconstructed audio signal of the scene audio signal is obtained based on attribute information of a target virtual loudspeaker, the residual signal, and the virtual loudspeaker signal. In this case, a decoding operation may be performed by the decoder, and another operation may be performed by another module.

In a third decoding scheme (corresponding to the foregoing third encoding scheme), the bitstream may be decoded to obtain a first reconstructed signal and attribute information of a target virtual loudspeaker; subsequently, a virtual loudspeaker signal corresponding to the target virtual loudspeaker is generated based on the attribute information and the first reconstructed signal; and then, reconstruction is performed based on the attribute information and the virtual loudspeaker signal to obtain the reconstructed audio signal of the scene audio signal. In this case, a decoding operation may be performed by the decoder, and another operation may be performed by another module.

For example, a decoder side may parse the bitstream to obtain the metadata of the scene audio signal based on a syntax element of the metadata of the scene audio signal and corresponding description information in a syntax structure of the bitstream. In the embodiment in FIG. 4A, the metadata of the scene audio signal may include only first metadata. Then, the decoder side may perform rendering based on the first metadata obtained from the bitstream through parsing and the reconstructed audio signal obtained based on the bitstream, to obtain a binaural rendered signal. In this case, the decoder side may obtain second metadata from another device or locally generate second metadata. This is not limited in this application. In addition, a quantity Y of virtual loudspeakers in a rendering process may be a user-defined value, or may be a default value. This is not limited in this application.

FIG. 4B is a diagram of an example process of generating a binaural rendered signal. FIG. 4B is shown based on FIG. 3A and FIG. 4A.

Refer to FIG. 4B. For example, after encoding a scene audio signal and metadata of the scene audio signal to obtain a bitstream, an encoder side transmits the bitstream to a decoder side. After receiving the bitstream, the decoder side may obtain a reconstructed audio signal of the scene audio signal based on the bitstream, and parse the bitstream to obtain the metadata of the scene audio signal; and then render the reconstructed audio signal of the scene audio signal based on the metadata of the scene audio signal, a user position, and a user posture, to obtain a binaural rendered signal.

For example, in this application, a first identifier indicating rendering complexity may be further written into the bitstream. The rendering complexity is used to determine a quantity Y of virtual loudspeakers in a rendering process. In other words, the decoder side may render a virtual loudspeaker signal based on the metadata of the scene audio signal, the rendering complexity indicated by the first identifier, the user position, and the user posture, to obtain a binaural rendered signal. In this way, a binaural rendered signal whose audio quality matches factors such as a user requirement and a computing capability of an electronic device can be obtained through rendering.

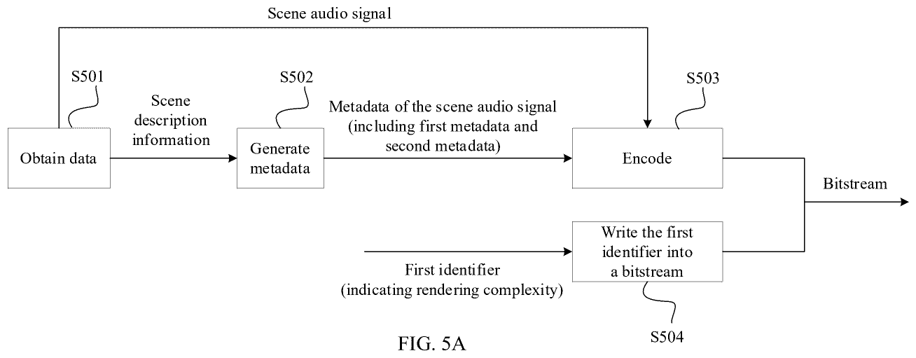

FIG. 5A is a diagram of an example encoding process. In the embodiment in FIG. 5A, metadata of a scene audio signal is determined based on scene description information, and the metadata of the scene audio signal may include first metadata and second metadata.
S501: Obtain a scene audio signal and scene description information of a scene.

For example, an encoder side may locally obtain the scene description information of the scene, or may obtain the scene description information of the scene from a third electronic device. This is not limited in this application.
S502: Determine metadata of the scene audio signal based on the scene description information of the scene.

For example, the metadata of the scene audio signal may include first metadata and second metadata.

In a possible manner, the first metadata may be determined based on a product of a room critical distance and a preset value. For details, refer to the following Formula (9):

$$k = \frac{1.5}{Room critical distance} \qquad ( 9 )$$

k in Formula (9) is the first metadata, and k∈[0.5,1.5]. 1.5 in Formula (9) is a preset value.

In a possible manner, a reverberation type of the scene may be determined based on an acoustic reverberation parameter in the scene, and then the first metadata is determined based on the reverberation type of the scene. Specifically, corresponding first metadata may be preset for different reverberation types. For example, for a first reverberation type (corresponding to a dry sound scene or a non-reverberant room), corresponding first metadata is set to 0.5, and for a second reverberation type (corresponding to a wet sound scene or a reverberant room), corresponding first metadata is set to 1.5. In this way, when it is determined that the reverberation type of the scene is the first reverberation type, 0.5 may be used as the first metadata; or when it is determined that the reverberation type of the scene is the second reverberation type, 1.5 may be used as the first metadata.

In a possible manner, position information of HOA microphones at a plurality of points in the scene included in the scene description information may be used as the second metadata.

In a possible manner, a distance between HOA microphones at two points in the HOA microphones at the plurality of points may be determined based on the position information of the HOA microphones at the plurality of points in the scene included in the scene description information; and then the distance between the HOA microphones at the two points in the HOA microphones at the plurality of points is used as the second metadata.

For example, when the first metadata is input by a user, a value range of the first metadata may be limited to k∈[0.25,4].

It should be understood that the first metadata may further have another generation manner, and the metadata of the scene audio signal may further include other metadata. This is not limited in this application.
S503: Encode the scene audio signal and the metadata of the scene audio signal to obtain a bitstream.

For example, for S503, refer to the foregoing descriptions of S302. Details are not described herein again.
S504: Write a first identifier into the bitstream.

For example, a plurality of rendering complexity levels may be preset, as shown in Table 2.

TABLE 2

| Rendering | Number of | | | |
|---|---|---|---|---|
| complexity | virtual | Number of | Rendering | Audio |
| level | loudspeakers | convolutions | complexity | quality |
| 0 | (N + 1)² | 2(N + 1)² | Depending | Depending |
| | | | on an HOA | on an HOA |
| | | | signal | signal |
| 1 | 4 | 8 | Lowest | Lowest |
| 2 | 9 | 18 | Low | Low |
| 3 | 16 | 32 | High | High |
| 4 | 25 | 50 | Highest | Highest |

The number of virtual loudspeakers in Table 2 is Y.

Refer to Table 2. For example, rendering complexity may be classified into five levels. In a level 1 to a level 4, a larger number of virtual loudspeakers indicates a larger number of convolutions in a rendering process, higher rendering complexity, and higher audio quality.

Refer to Table 2. For example, for a level 0, N is an order of an HOA signal, a number of virtual loudspeakers is (N+1)², a number of convolutions is 2(N+1), and both rendering complexity and audio quality depend on the HOA signal.

It should be understood that Table 2 is merely an example in this application, and the rendering complexity levels may be set according to a requirement. This is not limited in this application.

In a possible manner, a target rendering complexity level may be selected from the plurality of rendering complexity levels in Table 2 based on a computing capability of a decoder side; and a value of the first identifier is set to the target rendering complexity level.

In a possible manner, the user may input a target rendering complexity level based on the plurality of rendering complexity levels in Table 2, and a value of the first identifier is set to the target rendering complexity level that is input by the user.

For example, in the embodiment in FIG. 5A, in this application, a syntax element of the metadata of the scene audio signal and corresponding description information, and a syntax element of the first identifier and corresponding description information may be added in advance to an original syntax structure of the bitstream. In this way, the encoder side may write the first identifier into the bitstream based on the syntax element of the first identifier and the corresponding description information in the syntax structure of the bitstream; and write the metadata of the scene audio signal into the bitstream based on the syntax element of the metadata of the scene audio signal and the corresponding description information in the syntax structure of the bitstream.

It should be noted that a sequence of performing S503 and S504 is not limited in this application.

For example, the syntax structure of the bitstream may be shown in the following Table 3.

TABLE 3

| Syntax | No. of bits | Mnemonic |
|---|---|---|
| Syntax element 1 | | |
| { | | |
| Syntax element 2 | 1 | bslbf |
| Syntax element 3 | 3 | bslbf |
| ... | | |
| Syntax element n | 4 | uimsbf |
| } | | |
| ... | | |
| Syntax element n+1 | | |
| distanceFactor | 8 | uimsbf |
| complexityLevel | 3 | uimsbf |

Refer to Table 3. In the embodiment in FIG. 5A, syntax elements “distanceFactor” and “complexityLevel” are newly added in this application, where “distanceFactor” is the syntax element of the metadata of the scene audio signal, and “complexityLevel” is the syntax element of the first identifier.

“3” in the last row in Table 3 indicates that the first identifier in the bitstream may be represented by using 3 bits, and “uimsbf” in the last row in Table 3 indicates that the first identifier in the bitstream is an unsigned integer, most significant bit first. It should be understood that Table 3 is merely an example of this application. The first identifier may be alternatively represented by using another number of bits, for example, 4 bits. This is not limited in this application. Further, in addition to being represented by using “complexityLevel”, the syntax element of the first identifier may be alternatively represented by using another character string. This is not limited in this application.

For explanations of other syntax elements in Table 3, refer to the descriptions in Table 1. Details are not described herein again.

For example, if the syntax structure of the bitstream is shown in Table 3, in a process of performing S503, the metadata of the scene audio signal may be converted into an 8-bit binary number; and then the 8-bit binary number is written after data identified by the syntax element n+1 in the bitstream. In addition, in a process of performing S504, the first identifier may be converted into a 3-bit binary number; and then the 3-bit binary number is written after the metadata of the scene audio signal in the bitstream.

FIG. 5B is a diagram of an example bitstream structure. A bitstream structure in the embodiment in FIG. 5A may be shown in FIG. 5B, that is, the metadata of the scene audio signal is after encoded data of the scene audio signal, and the first identifier is after the metadata of the scene audio signal.

It should be understood that positions of the metadata of the scene audio signal, the encoded data of the scene audio signal, and the first identifier in the bitstream are not limited in this application.

It should be understood that, in the bitstream in this application, any two of the metadata of the scene audio signal, the encoded data of the scene audio signal, and the first identifier may be adjacent or may not be adjacent. This is not limited in this application.

FIG. 6A is a diagram of an example decoding process. The decoding process in FIG. 6A corresponds to the encoding process in FIG. 5A.
S601: Receive a bitstream.
S602: Obtain a reconstructed audio signal of a scene audio signal based on the bitstream.
S603: Parse the bitstream to obtain metadata of the scene audio signal.
S604: Parse the bitstream to obtain a first identifier.

For example, a sequence of performing S602, S603, and S604 is not limited in this application.

For example, after receiving the bitstream, a decoder side may obtain the reconstructed audio signal of the scene audio signal based on the bitstream. For details, refer to the descriptions in the embodiment in FIG. 4A. Details are not described herein again.

For example, the decoder side may further parse the bitstream to obtain the metadata of the scene audio signal based on a syntax element of the metadata of the scene audio signal and corresponding description information in a syntax structure of the bitstream. In addition, the decoder side may further parse the bitstream to obtain the first identifier based on a syntax element of the first identifier and corresponding description information in the syntax structure of the bitstream.

Subsequently, the decoder side may perform rendering based on the reconstructed signal of the scene audio signal, first metadata, second metadata, and the first identifier, to obtain a binaural rendered signal. In this case, the decoder side may parse the bitstream to obtain the second metadata and the first metadata. In addition, in a rendering process, a quantity Y of selected virtual loudspeakers may be determined based on the first identifier.

FIG. 6B is a diagram of an example process of generating a binaural rendered signal. FIG. 6B is shown based on FIG. 5A and FIG. 6A.

Refer to FIG. 6B. For example, after encoding a scene audio signal, metadata of the scene audio signal, and a first identifier into a bitstream, an encoder side transmits the bitstream to a decoder side. After receiving the bitstream, the decoder side may obtain a reconstructed audio signal of the scene audio signal based on the bitstream, parse the bitstream to obtain the metadata of the scene audio signal and the first identifier, and then render the reconstructed audio signal of the scene audio signal based on the metadata of the scene audio signal, a rendering complexity level indicated by the first identifier, a user position, and a user posture, to obtain a binaural rendered signal.

It should be noted that, in FIG. 6B, the first identifier, the rendering complexity level indicated by the first identifier, or a quantity Y of virtual loudspeakers corresponding to the rendering complexity level indicated by the first identifier may be input into a renderer. This is not limited in this application.

For example, there may be a plurality of renderers (each renderer uses a different rendering method) on a decoder side. The plurality of renderers include a renderer that performs rendering based on metadata of a scene audio signal (for example, a renderer that performs rendering by using the method in S11 to S16) and a renderer that performs rendering based on other information. Further, a corresponding identifier value may be set for each renderer. For example, for a renderer A, a corresponding identifier value is set to “0”; for a renderer B, a corresponding identifier value is set to “1”; and for a renderer C, a corresponding identifier value is set to “2”. When it is determined that the decoder side needs to perform rendering based on the metadata of the scene audio signal, in a possible manner, an identifier value (which is subsequently referred to as a first identifier value) of the renderer that performs rendering based on the metadata of the scene audio signal may be used as an identifier value of a second identifier; or in a possible manner, a second identifier value (for example, “0” or “1”, which may be set according to a requirement) may be used as an identifier value of a second identifier; and then the second identifier is added to a bitstream. The second identifier value indicates the decoder side to perform rendering based on the metadata of the scene audio signal. In other words, the second identifier value indicates that the bitstream includes the metadata of the scene audio signal. In this way, it is convenient for the decoder side to determine which renderer or which rendering algorithm is to be used for rendering.

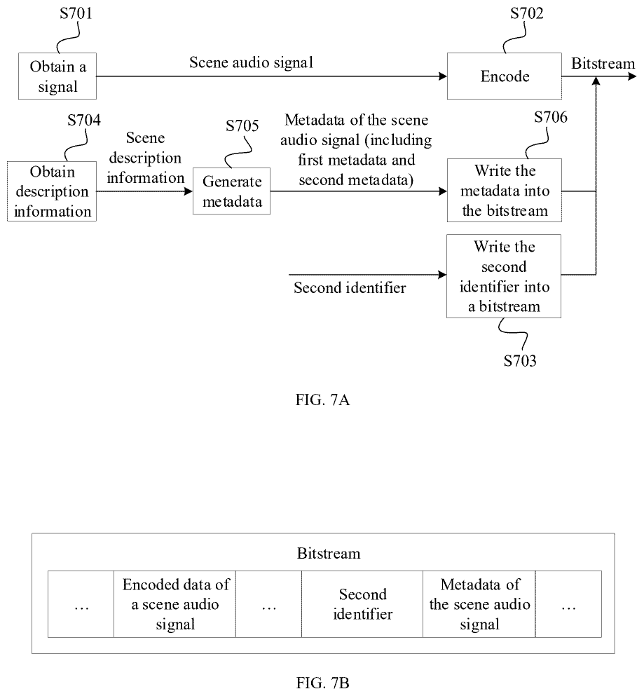

FIG. 7A is a diagram of an example encoding process. It should be noted that FIG. 7A is shown based on FIG. 3A. In the embodiment in FIG. 7A, metadata of a scene audio signal is determined based on scene description information.
S701: Obtain a scene audio signal.
S702: Encode the scene audio signal to obtain a bitstream.

For example, for S701 and S702, refer to the foregoing descriptions. Details are not described herein again.
S703: Write a second identifier into the bitstream.

Both the first identifier value and the second identifier value described above may be referred to as a first preset identifier value. In other words, when it is determined that a decoder side needs to use metadata of the scene audio signal for rendering, a value of the second identifier may be set to the first preset identifier value, and then the first preset identifier value is written into the bitstream. When it is determined that a decoder side does not need to use metadata of the scene audio signal for rendering, a value of the second identifier may be set to another identifier value (the another identifier value is different from the first preset identifier value), and then the another identifier value is written into the bitstream.
S704: Obtain scene description information of a scene.
S705: Determine the metadata of the scene audio signal based on the scene description information of the scene.
S706: Write the metadata of the scene audio signal into the bitstream.

For example, for S704 to S706, refer to the foregoing descriptions of S501 to S503. Details are not described herein again.

For example, in the embodiment in FIG. 7A, in this application, a syntax element of the metadata of the scene audio signal and corresponding description information, and a syntax element of the second identifier and corresponding description information may be added in advance to an original syntax structure of the bitstream. In this way, an encoder side may write the second identifier into the bitstream based on the syntax element of the second identifier and the corresponding description information in the syntax structure of the bitstream.

For example, the syntax structure of the bitstream may be shown in the following Table 4.

TABLE 4

| Syntax | No. of bits | Mnemonic |
|---|---|---|
| Syntax element 1 | | |
| { | | |
| Syntax element 2 | 1 | bslbf |
| Syntax element 3 | 3 | bslbf |
| ... | | |
| Syntax element n | 4 | uimsbf |
| } | | |
| ... | | |
| Syntax element n+1 | | |
| hoaGroupHasLowProfileConfig | 1 | bslbf |
| if (hoaGroupHasLowProfileConfig) { | | |
| distanceFactor | 3 | uimsbf |
| } | | |

Refer to Table 4. In the embodiment in FIG. 7A, syntax elements “distanceFactor” and “hoaGroupHasLowProfileConfig” are newly added in this application, where “distanceFactor” is the syntax element of the metadata of the scene audio signal, and “hoaGroupHasLowProfileConfig” is the syntax element of the second identifier.

“1” in the fourth-to-last row in Table 4 indicates that the second identifier in the bitstream may be represented by using 1 bit, and “bslbf” in the fourth-to-last row in Table 4 indicates that the second identifier in the bitstream is a bit string, left bit first. It should be understood that Table 4 is merely an example of this application. The second identifier may be alternatively represented by using another number of bits, for example, 2 bits. This is not limited in this application. In addition, the syntax element of the second identifier may be alternatively represented by using another character string of the second identifier. This is not limited in this application.

For explanations of other syntax elements in Table 4, refer to the descriptions in Table 1. Details are not described herein again.

For example, if the syntax structure of the bitstream is shown in Table 4, in a process of performing S703, the second identifier may be converted into a 1-bit binary number; and then the 1-bit binary number is written after data identified by the syntax element n+1 in the bitstream. In addition, in a process of performing S706, the metadata of the scene audio signal may be converted into an 8-bit binary number; and then the 8-bit binary number is written after the second identifier in the bitstream. When the syntax structure of the bitstream is shown in Table 4, the value of the second identifier is “1”.

In a possible manner, a first identifier value of a renderer that performs rendering based on the metadata of the scene audio signal may be alternatively used as the value of the second identifier. If the first identifier value of the renderer that performs rendering based on the metadata of the scene audio signal is “3”, the syntax structure of the bitstream may be shown in Table 5.

For example, the syntax structure of the bitstream may be shown in the following Table 5.

TABLE 5

| Syntax | No. of bits | Mnemonic |
|---|---|---|
| Syntax element 1 | | |
| { | | |
| Syntax element 2 | 1 | bslbf |
| Syntax element 3 | 3 | bslbf |
| ... | | |
| Syntax element n | 4 | uimsbf |
| } | | |
| ... | | |
| Syntax element n+1 | | |
| hoaGroupHasLowProfileConfig | 2 | bslbf |
| if (hoaGroupHasLowProfileConfig==3) { | | |
| distanceFactor | 3 | uimsbf |
| } | | |

FIG. 7B is a diagram of an example bitstream structure. A bitstream structure in the embodiment in FIG. 7A may be shown in FIG. 7B, that is, the second identifier is after encoded data of the scene audio signal, and the metadata of the scene audio signal is after the second identifier.

It should be understood that positions of the metadata of the scene audio signal, the encoded data of the scene audio signal, and the second identifier in the bitstream are not limited in this application.

It should be understood that, in the bitstream in this application, any two of the metadata of the scene audio signal, the encoded data of the scene audio signal, and the second identifier may be adjacent or may not be adjacent. This is not limited in this application.

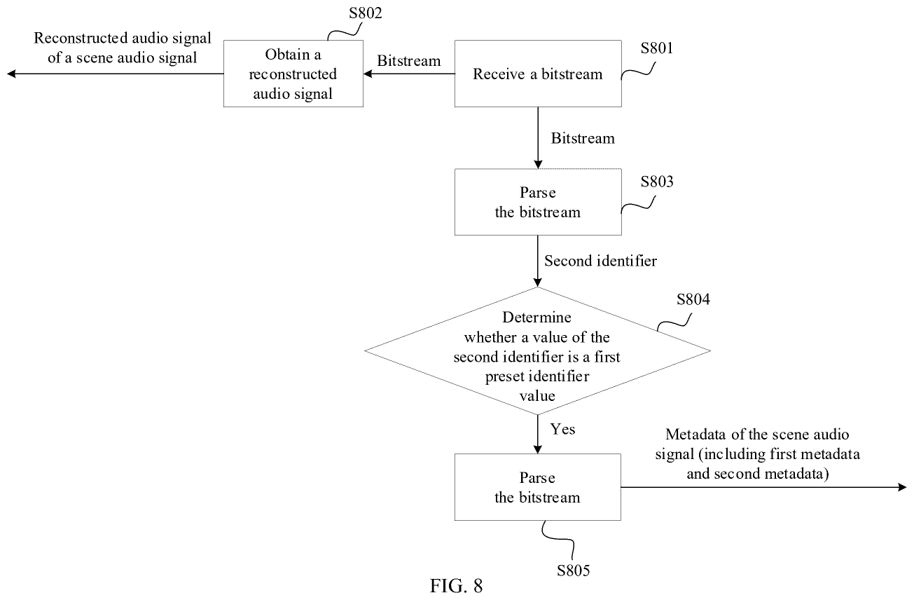

FIG. 8 is a diagram of an example decoding process. The decoding process in FIG. 8 corresponds to the encoding process in FIG. 7A.
S801: Receive a bitstream.
S802: Obtain a reconstructed audio signal of a scene audio signal based on the bitstream.

For example, for S801 and S802, refer to the foregoing descriptions. Details are not described herein again.
S803: Parse the bitstream to obtain a second identifier.
S804: Determine whether a value of the second identifier is a first preset identifier value.

For example, the bitstream may be first parsed to obtain the second identifier; and then, whether the second identifier is the first preset identifier value is determined, to determine whether metadata of the scene audio signal can be obtained from the bitstream through parsing.

For example, when the value of the second identifier is the first preset identifier value, it indicates that the bitstream includes the metadata of the scene audio signal. In this case, S805 may be performed. When the value of the second identifier is another identifier value, it indicates that the bitstream does not include the metadata of the scene audio signal. In this case, a field after the second identifier in the bitstream is decoded.

For example, when a bitstream structure of the bitstream is shown in Table 4, whether the value of the second identifier is 1 may be determined. When the value of the second identifier is 1, it indicates that the bitstream includes the metadata of the scene audio signal; or when the value of the second identifier is not 1, it indicates that the bitstream does not include the metadata of the scene audio signal.

For example, when a bitstream structure of the bitstream is shown in Table 5, whether the value of the second identifier is 3 may be determined. When the value of the second identifier is 3, it indicates that the bitstream includes the metadata of the scene audio signal; or when the value of the second identifier is not 3, it indicates that the bitstream does not include the metadata of the scene audio signal.
S805: Parse the bitstream to obtain the metadata of the scene audio signal.

For example, there may be a plurality of renderers (each renderer uses a different rendering method) on a decoder side. The plurality of renderers include a renderer that performs rendering based on metadata of a scene audio signal and a first identifier (for example, a renderer that performs rendering by using the method in S11 to S16) and a renderer that performs rendering based on other information. Further, a corresponding identifier value may be set for each renderer. For example, for a renderer A, a corresponding identifier value is set to “0”; for a renderer B, a corresponding identifier value is set to “1”; and for a renderer C, a corresponding identifier value is set to “2”. When it is determined that the decoder side needs to perform rendering based on the metadata of the scene audio signal and the first identifier, in a possible manner, an identifier value (which is subsequently referred to as a first identifier value) of the renderer that performs rendering based on the metadata of the scene audio signal and the first identifier may be used as an identifier value of a second identifier; or in a possible manner, a second identifier value (for example, “0” or “1”, which may be set according to a requirement) may be used as an identifier value of a second identifier; and then the second identifier is added to a bitstream. The second identifier value indicates the decoder side to perform rendering based on the metadata of the scene audio signal and the first identifier. In other words, the second identifier value indicates that the bitstream includes the metadata of the scene audio signal and the first identifier. In this way, it is convenient for the decoder side to determine which renderer or which rendering algorithm is to be used for rendering.

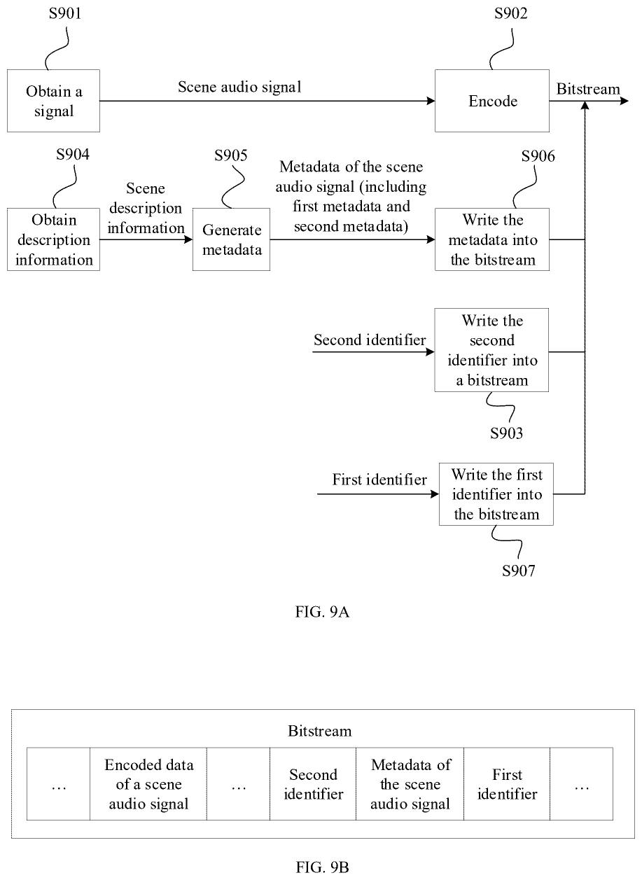

FIG. 9A is a diagram of an example encoding process. It should be noted that FIG. 9A is shown based on FIG. 5A. In the embodiment in FIG. 9A, metadata of a scene audio signal is determined based on scene description information.
S901: Obtain a scene audio signal.
S902: Encode the scene audio signal to obtain a bitstream.

For example, for S901 and S902, refer to the foregoing descriptions. Details are not described herein again.
S903: Write a second identifier into the bitstream.
S904: Obtain scene description information of a scene.
S905: Determine metadata of the scene audio signal based on the scene description information of the scene.
S906: Write the metadata of the scene audio signal into the bitstream.
S907: Write a first identifier into the bitstream.

For example, a sequence of performing S906 and S907 is not limited in this application.

For example, in the embodiment in FIG. 9A, in this application, a syntax element of the metadata of the scene audio signal and corresponding description information, a syntax element of the second identifier and corresponding description information, and a syntax element of the first identifier and corresponding description information may be added in advance to an original syntax structure of the bitstream.

For example, the syntax structure of the bitstream may be shown in the following Table 6.

TABLE 6

| Syntax | No. of bits | Mnemonic |
|---|---|---|
| Syntax element 1 | | |
| { | | |
| Syntax element 2 | 1 | bslbf |
| Syntax element 3 | 3 | bslbf |
| ... | | |
| Syntax element n | 4 | uimsbf |
| } | | |
| ... | | |
| Syntax element n+1 | | |
| hoaGroupHasLowProfileConfig | 1 | bslbf |
| if (hoaGroupHasLowProfileConfig) { | | |
| distanceFactor | 3 | uimsbf |
| complexityLevel | 3 | uimsbf |
| } | | |

FIG. 9B is a diagram of an example bitstream structure. FIG. 9B is a diagram of an example bitstream structure. A bitstream structure in the embodiment in FIG. 9A may be shown in FIG. 9B, that is, the second identifier is after encoded data of the scene audio signal, the metadata of the scene audio signal is after the second identifier, and the first identifier is after the metadata of the scene audio signal.

It should be understood that positions of the metadata of the scene audio signal, the encoded data of the scene audio signal, the first identifier, and the second identifier in the bitstream are not limited in this application.

It should be understood that, in the bitstream in this application, any two of the metadata of the scene audio signal, the encoded data of the scene audio signal, the first identifier, and the second identifier may be adjacent or may not be adjacent. This is not limited in this application.

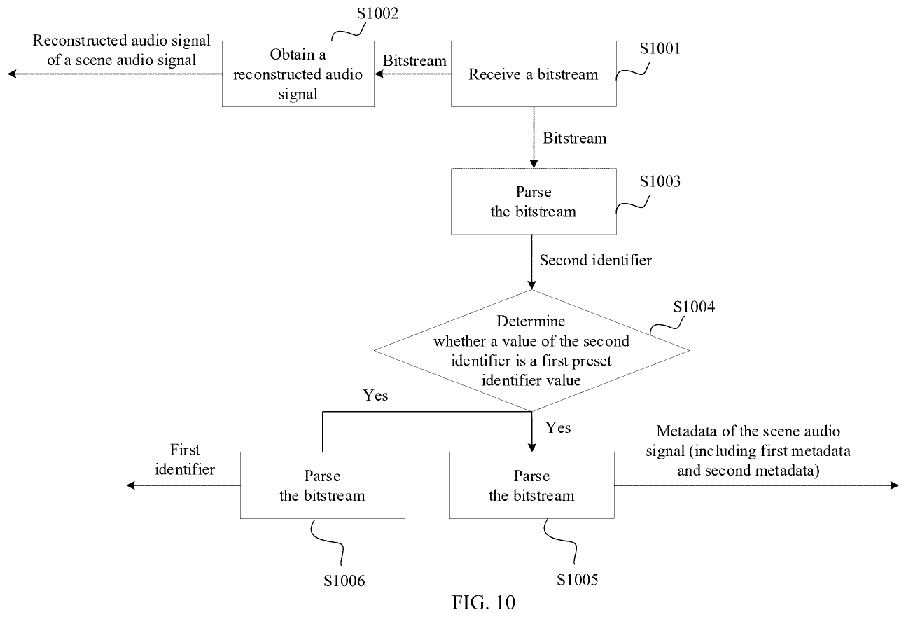

FIG. 10 is a diagram of an example decoding process. The decoding process in FIG. 10 corresponds to the encoding process in FIG. 9A.
S1001: Receive a bitstream.
S1002: Obtain a reconstructed audio signal of a scene audio signal based on the bitstream.
S1003: Parse the bitstream to obtain a second identifier.
S1004: Determine whether a value of the second identifier is a first preset identifier value.
S1005: Parse the bitstream to obtain metadata of the scene audio signal.
S1006: Parse the bitstream to obtain a first identifier.

For example, for S1001 to S1006, refer to the descriptions in the foregoing embodiments. Details are not described herein again.

It should be noted that, in the embodiments in FIG. 5A to FIG. 10, in the encoding process, a third identifier may be further written into the bitstream, and the third identifier may indicate whether the bitstream includes the first identifier. In this case, the second identifier may indicate only whether the bitstream includes the metadata of the scene audio signal. For example, when the first identifier is written into the bitstream, a value of the third identifier may be set to a second preset identifier value, and then the second preset identifier value is written into the bitstream.

Correspondingly, in this application, a syntax element of the metadata of the scene audio signal and corresponding description information, a syntax element of the second identifier and corresponding description information, a syntax element of the first identifier and corresponding description information, and a syntax element of the third identifier and corresponding description information may be added in advance to an original syntax structure of the bitstream.

For example, the syntax structure of the bitstream may be shown in the following Table 7.

TABLE 7

| Syntax | No. of bits | Mnemonic |
|---|---|---|
| Syntax element 1 | | |
| { | | |
| Syntax element 2 | 1 | bslbf |
| Syntax element 3 | 3 | bslbf |
| ... | | |
| Syntax element n | 4 | uimsbf |
| } | | |
| ... | | |
| Syntax element n+1 | | |
| hoaGroupHasLowProfileConfig | 1 | bslbf |
| if (hoaGroupHasLowProfileConfig) { | | |
| distanceFactor | 3 | uimsbf |
| } | | |
| hoaGroupHascomplexityConfig | | |
| if (hoaGroupHascomplexityConfig) { | | |
| complexityLevel | 3 | uimsbf |
| } | | |

In Table 7, “hoaGroupHascomplexityConfig” is the syntax element of the third identifier, and the second preset identifier value is “1”.

In this way, a decoder side may decode the bitstream to obtain the third identifier. When determining that the value of the third identifier is the second preset identifier value, the decoder side may determine that the bitstream includes the first identifier; and then decode the bitstream to obtain the first identifier.

For example, in this application, only the first identifier may be written into the bitstream. In this case, the decoder side may obtain the metadata of the scene audio signal from another electronic device or locally generate the metadata of the scene audio signal.

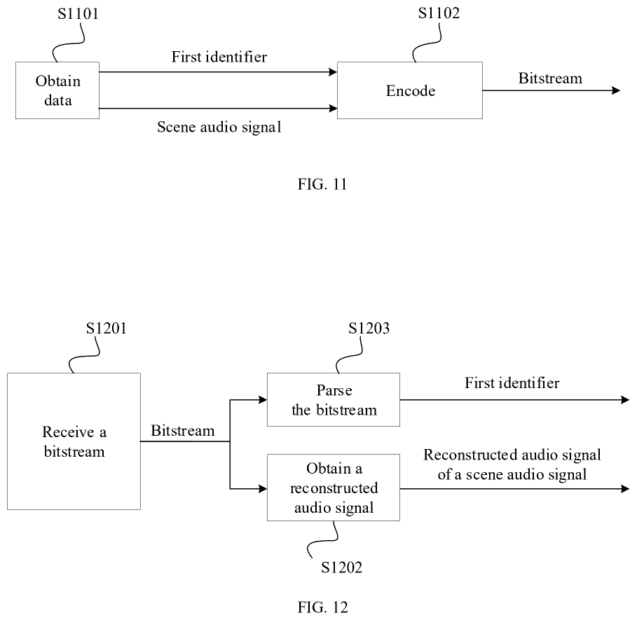

FIG. 11 is a diagram of an example encoding process.
S1101: Obtain a scene audio signal.
S1102: Encode the scene audio signal and a first identifier to obtain a bitstream, where the first identifier indicates rendering complexity, the rendering complexity is used to determine a number of virtual loudspeakers, a reconstructed audio signal of the scene audio signal is used to generate a virtual loudspeaker signal, and the virtual loudspeaker signal and the number of virtual loudspeakers are used for rendering to obtain a rendered audio signal.

For S1101 and S1102, refer to the foregoing descriptions. Details are not described herein again.

A syntax element of the first identifier and corresponding description information may be added to a syntax structure of the bitstream.

For example, the syntax structure of the bitstream may be shown in the following Table

TABLE 8

| Syntax | No. of bits | Mnemonic |
|---|---|---|
| Syntax element 1 | | |
| { | | |
| Syntax element 2 | 1 | bslbf |
| Syntax element 3 | 3 | bslbf |
| ... | | |
| Syntax element n | 4 | uimsbf |
| } | | |
| ... | | |
| Syntax element n+h | | |
| complexityLevel | 3 | uimsbf |

FIG. 12 is a diagram of an example decoding process. The decoding process in FIG. 12 corresponds to the encoding process in FIG. 11.
S1201: Receive a bitstream.
S1202: Obtain a reconstructed audio signal of a scene audio signal based on the bitstream.
S1203: Parse the bitstream to obtain a first identifier, where the first identifier indicates rendering complexity, the rendering complexity is used to determine a number of virtual loudspeakers, the reconstructed audio signal is used to generate a virtual loudspeaker signal, and the virtual loudspeaker signal and the number of virtual loudspeakers are used for rendering to obtain a rendered audio signal.

For example, for S1201 to S1203, refer to the foregoing descriptions. Details are not described herein again.

In addition, based on FIG. 11 and FIG. 12, an encoder side may further write a second identifier into the bitstream, where the second identifier indicates whether the bitstream includes the first identifier. For example, when the first identifier is written into the bitstream, a value of the second identifier may be set to a preset identifier value, and then the preset identifier value is written into the bitstream.

For example, the syntax structure of the bitstream may be shown in the following Table 9.

TABLE 9

| Syntax | No. of bits | Mnemonic |
|---|---|---|
| Syntax element 1 | | |
| { | | |
| Syntax element 2 | 1 | bslbf |
| Syntax element 3 | 3 | bslbf |
| ... | | |
| Syntax element n | 4 | uimsbf |
| } | | |
| ... | | |
| Syntax element n+1 | | |
| hoaGroupHascomplexityConfig | | |
| if (hoaGroupHascomplexityConfig) { | | |
| complexityLevel | 3 | uimsbf |
| } | | |

In Table 9, “hoaGroupHascomplexityConfig” is a syntax element of the second identifier, and the preset identifier value is “1”.

In this way, a decoder side may decode the bitstream to obtain the second identifier. When determining that the value of the second identifier is the preset identifier value, the decoder side may determine that the bitstream includes the first identifier; and then decode the bitstream to obtain the first identifier.

In addition, the syntax element of the second identifier and corresponding description information may be further added to the syntax structure of the bitstream. For details, refer to the foregoing descriptions. Details are not described herein again.

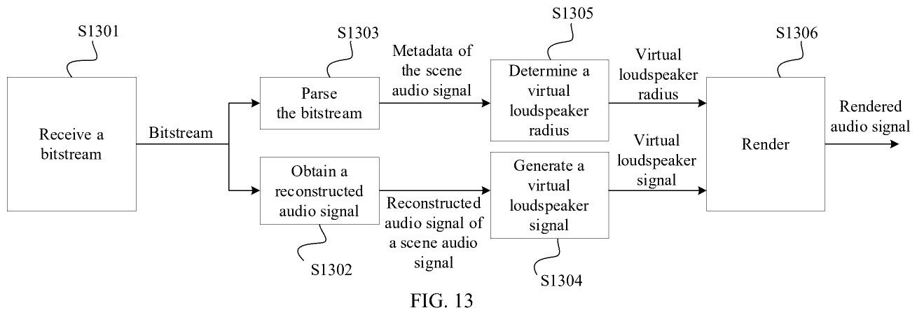

FIG. 13 is a diagram of an example process of generating a binaural rendered signal. The embodiment in FIG. 13 is performed by a terminal device, and the terminal device may include a decoder and a renderer. FIG. 13 is shown based on FIG. 4A.
S1301: Receive a bitstream.
S1302: Parse the bitstream to obtain metadata of a scene audio signal.
S1303: Obtain a reconstructed audio signal of the scene audio signal based on the bitstream.

For example, for S1301 to S1303, refer to the foregoing descriptions of S401 to S403. Details are not described herein again.
S1304: Generate a virtual loudspeaker signal based on the reconstructed audio signal of the scene audio signal.
S1305: Determine a virtual loudspeaker radius based on first metadata and a distance between two of a plurality of microphones.
S1306: Perform rendering based on the virtual loudspeaker radius and the virtual loudspeaker signal, to obtain a rendered audio signal.

For S1304 to S1306, refer to the foregoing descriptions of S11 to S16. Details are not described herein again.

It should be noted that S1305 and S1306 may be performed by the renderer. In a possible manner, S1301 to S1303 may be performed by the decoder. In a possible manner, S1301 and S1302 may be performed by the decoder, and S1303 may be collaboratively implemented by the decoder and another module.

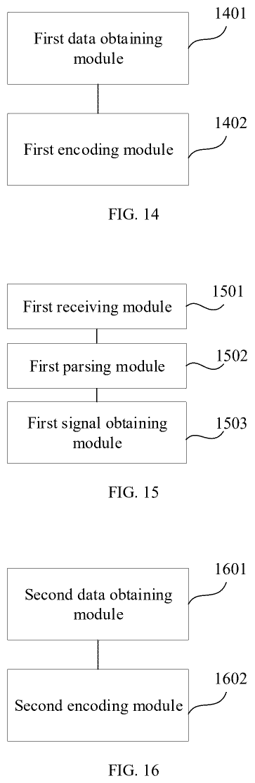

FIG. 14 is a diagram of an example encoding apparatus. The encoding apparatus may be configured to perform the method in the foregoing embodiments. Therefore, for beneficial effects that can be achieved by the encoding apparatus, refer to beneficial effects in the corresponding method provided above. Details are not described herein again.

A first data obtaining module 1401 is configured to obtain a scene audio signal and metadata of the scene audio signal, where the scene audio signal describes a sound field of a sound source in a scene, the scene includes a plurality of microphones, the metadata includes first metadata, the first metadata is used in combination with a distance between two of the plurality of microphones to determine a virtual loudspeaker radius, the virtual loudspeaker radius and a virtual loudspeaker signal are used for rendering to obtain a rendered audio signal, and the virtual loudspeaker signal is generated based on a reconstructed audio signal of the scene audio signal.

A first encoding module 1402 is configured to encode the scene audio signal and the metadata to obtain a bitstream.

FIG. 15 is a diagram of an example decoding apparatus. The decoding apparatus may be configured to perform the method in the foregoing embodiments. Therefore, for beneficial effects that can be achieved by the decoding apparatus, refer to beneficial effects in the corresponding method provided above. Details are not described herein again.

A first receiving module 1501 is configured to receive a bitstream.

A first parsing module 1502 is configured to parse the bitstream to obtain metadata of a scene audio signal.

A first signal obtaining module 1503 is configured to obtain a reconstructed audio signal of the scene audio signal based on the bitstream, where the scene audio signal describes a sound field of a sound source in a scene, the scene includes a plurality of microphones, the metadata includes first metadata, the first metadata is used in combination with a distance between two of the plurality of microphones to determine a virtual loudspeaker radius, the virtual loudspeaker radius and a virtual loudspeaker signal are used for rendering to obtain a rendered audio signal, and the virtual loudspeaker signal is generated based on the reconstructed audio signal.

FIG. 16 is a diagram of an example encoding apparatus. The encoding apparatus may be configured to perform the method in the foregoing embodiments. Therefore, for beneficial effects that can be achieved by the encoding apparatus, refer to beneficial effects in the corresponding method provided above. Details are not described herein again.

A second data obtaining module 1601 is configured to obtain a scene audio signal.

A second encoding module 1602 is configured to encode the scene audio signal and a first identifier to obtain a bitstream, where the first identifier indicates rendering complexity, the rendering complexity is used to determine a number of virtual loudspeakers, a reconstructed audio signal of the scene audio signal is used to generate a virtual loudspeaker signal, and the virtual loudspeaker signal and the number of virtual loudspeakers are used for rendering to obtain a rendered audio signal.

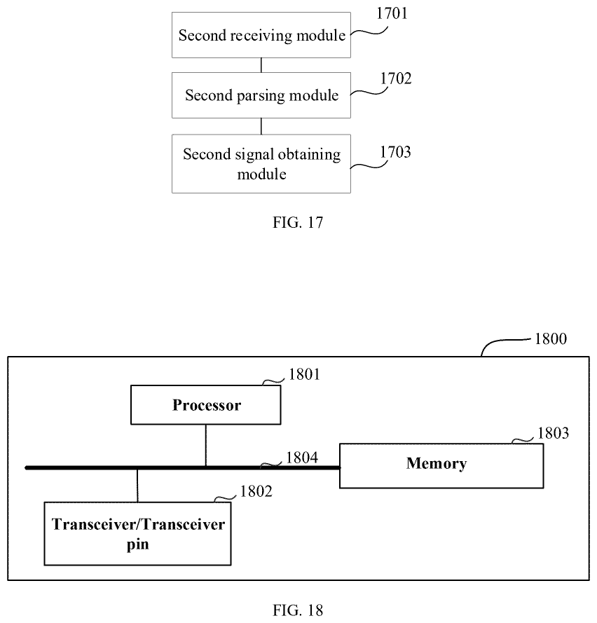

FIG. 17 is a diagram of an example decoding apparatus. The decoding apparatus may be configured to perform the method in the foregoing embodiments. Therefore, for beneficial effects that can be achieved by the decoding apparatus, refer to beneficial effects in the corresponding method provided above. Details are not described herein again.

A second receiving module 1701 is configured to receive a bitstream.

A second parsing module 1702 is configured to parse the bitstream to obtain a first identifier.

A second signal obtaining module 1703 is configured to obtain a reconstructed audio signal of a scene audio signal based on the bitstream, where the first identifier indicates rendering complexity, the rendering complexity is used to determine a number of virtual loudspeakers, the reconstructed audio signal is used to generate a virtual loudspeaker signal, and the virtual loudspeaker signal and the number of virtual loudspeakers are used for rendering to obtain a rendered audio signal.

In an example, FIG. 18 is a block diagram of an apparatus 1800 according to an embodiment of this application. The apparatus 1800 may include a processor 1801 and a transceiver/transceiver pin 1802, and optionally, further includes a memory 1803.

Components of the apparatus 1800 are coupled together by using a bus 1804. In addition to a data bus, the bus 1804 further includes a power bus, a control bus, and a status signal bus. However, for clear description, various buses are referred to as the bus 1804 in the figure.

Optionally, the memory 1803 may be configured to store instructions in the foregoing method embodiments. The processor 1801 may be configured to execute the instructions in the memory 1803, control a receiving pin to receive a signal, and control a sending pin to send a signal.

The apparatus 1800 may be the electronic device or a chip in the electronic device in the foregoing method embodiments.

For example, the electronic device may be a terminal device or a server.

All related content of each operation in the foregoing method embodiment may be cited to a function description of a corresponding functional module, and details are not described herein again.

An embodiment of this application further provides a chip, including one or more interface circuits and one or more processors. The one or more processors receive or send data through the one or more interface circuits. When the one or more processors execute computer instructions, operations for implementing the method in the foregoing embodiments in the foregoing related method operations are performed. The interface circuit is the transceiver/transceiver pin 1802.

An embodiment further provides a computer-readable storage medium. The computer-readable storage medium stores computer instructions. When the computer instructions are run on an electronic device, the electronic device is enabled to perform the foregoing related method operations to implement the method in the foregoing embodiments.

An embodiment further provides a computer program product. The computer program product includes computer instructions, and when the computer instructions are executed by a computer or a processor, the computer is enabled to perform the foregoing related operations to implement the method in the foregoing embodiments.

In addition, an embodiment of this application further provides an apparatus. The apparatus may be specifically a chip, a component, or a module. The apparatus may include a processor and a memory that are connected. The memory is configured to store computer executable instructions. When the apparatus runs, the processor may execute the computer executable instructions stored in the memory, so that the chip performs the method in the foregoing method embodiments.

The electronic device, the computer-readable storage medium, the computer program product, or the chip provided in the embodiments is configured to perform the corresponding method provided above. Therefore, for beneficial effects that can be achieved, refer to beneficial effects in the corresponding method provided above. Details are not described herein again.

It may be learned by a person skilled in the art from the foregoing description of the embodiments that, for convenience and brevity of description, division into only the foregoing functional modules is used as an example for description. In actual application, the foregoing functions may be allocated to different functional modules for implementation according to a requirement, that is, an internal structure of an apparatus is divided into different functional modules, to complete all or some of the functions described above.

In the several embodiments provided in this application, it should be understood that the disclosed apparatus and method may be implemented in other manners. For example, the described apparatus embodiments are merely examples. For example, division into the modules or units is merely logical function division. In actual implementation, there may be another division manner. For example, a plurality of units or components may be combined or integrated into another apparatus, or some features may be ignored or not performed. In addition, the displayed or discussed mutual couplings or direct couplings or communication connections may be implemented through some interfaces, and indirect couplings or communication connections between apparatuses or units may be implemented in an electrical, mechanical, or another form.

The units described as separate parts may or may not be physically separate, and parts displayed as units may be one or more physical units, may be located in one place, or may be distributed in a plurality of different places. Some or all of the units may be selected according to an actual requirement to achieve the objectives of the solutions in the embodiments.

In addition, functional units in embodiments of this application may be integrated into one processing unit, or each unit may exist alone physically, or two or more units may be integrated into one unit. The integrated unit may be implemented in a form of hardware, or may be implemented in a form of a software functional unit.

Any content in embodiments of this application and any content in a same embodiment may be freely combined. Any combination of the foregoing content falls within the scope of this application.

When the integrated unit is implemented in a form of a software functional unit and sold or used as an independent product, the integrated unit may be stored in a readable storage medium. Based on such an understanding, the technical solutions of embodiments of this application essentially, or the part contributing to the conventional technology, or all or some of the technical solutions may be implemented in a form of a software product. The software product is stored in a storage medium and includes several instructions for instructing a device (which may be a single-chip microcomputer, a chip, or the like) or a processor to perform all or some of the operations of the methods described in embodiments of this application. The foregoing storage medium includes any medium that can store program code, such as a USB flash drive, a removable hard disk, a read-only memory (ROM), a random access memory (RAM), a magnetic disk, or an optical disc.

Embodiments of this application are described above with reference to the accompanying drawings. However, this application is not limited to the foregoing specific embodiments. The foregoing specific embodiments are merely an example but not a limitation. Many forms that can be made by a person of ordinary skill in the art without departing from the principle of this application and the protection scope of the claims fall within the protection scope of this application.

The method or algorithm operations described with reference to the content disclosed in embodiments of this application may be implemented in a hardware manner, or may be implemented in a manner in which a processor executes software instructions. The software instruction may include a corresponding software module. The software module may be stored in a random access memory (RAM), a flash memory, a read-only memory (ROM), an erasable programmable read-only memory (EPROM), an electrically erasable programmable read-only memory (EEPROM), a register, a hard disk, a removable hard disk, a compact disc read-only memory (CD-ROM), or any other form of storage medium well known in the art. An example storage medium is coupled to a processor, so that the processor can read information from the storage medium and can write information into the storage medium. Certainly, the storage medium may alternatively be a part of the processor. The processor and the storage medium may be located in an ASIC.

A person skilled in the art should be aware that in the foregoing one or more examples, functions described in embodiments of this application may be implemented by hardware, software, firmware, or any combination thereof. When implemented by software, these functions may be stored in a computer-readable medium or transmitted as one or more instructions or code on the computer-readable medium. The computer-readable medium includes a computer-readable storage medium and a communication medium. The communication medium includes any medium that facilitates transfer of a computer program from one place to another. The storage medium may be any usable medium accessible to a general-purpose or dedicated computer.

Embodiments of this application are described above with reference to the accompanying drawings. However, this application is not limited to the foregoing specific embodiments. The foregoing specific embodiments are merely an example but not a limitation. Many forms that can be made by a person of ordinary skill in the art without departing from the principle of this application and the protection scope of the claims fall within the protection scope of this application.

1. An encoding method, comprising:
obtaining a scene audio signal and metadata of the scene audio signal, wherein the scene audio signal describes a sound field of a sound source in a scene, the scene comprises a plurality of microphones, the metadata of the scene audio signal comprises first metadata, the first metadata is used in combination with a distance between two of the plurality of microphones to determine a virtual loudspeaker radius, the virtual loudspeaker radius and a virtual loudspeaker signal are used for rendering to obtain a rendered audio signal, and the virtual loudspeaker signal is generated based on a reconstructed audio signal of the scene audio signal; and
encoding the scene audio signal and the metadata of the scene audio signal to obtain a bitstream.

2. The method according to claim 1, wherein the method further comprises:
writing a first identifier into the bitstream, wherein the first identifier indicates rendering complexity, and the rendering complexity is used to determine a number of virtual loudspeakers; or
writing a second identifier into the bitstream, wherein the second identifier indicates whether the bitstream comprises the metadata of the scene audio signal.

3. The method according to claim 2, wherein
the second identifier further indicates whether the bitstream further comprises the first identifier; or
wherein the method further comprises:
writing a third identifier into the bitstream, wherein the third identifier indicates whether the bitstream comprises the first identifier.

4. The method according to claim 2, wherein the bitstream comprises a syntax element complexityLevel of the first identifier and corresponding description information; or
wherein the bitstream comprises a syntax element hoaGroupHasLowProfileConfig of the second identifier and corresponding description information.

5. The method according to claim 1, wherein obtaining the metadata of the scene audio signal comprises:
obtaining scene description information of the scene; and
determining the metadata of the scene audio signal based on the scene description information of the scene.

6. The method according to claim 5, wherein determining the metadata of the scene audio signal based on the scene description information of the scene comprises:
determining the first metadata based on a product of a room critical distance and a preset value when the scene description information comprises the room critical distance of the scene; or
determining a reverberation type of the scene based on an acoustic reverberation parameter of the scene when the scene description information comprises the acoustic reverberation parameter of the scene; and determining the first metadata based on the reverberation type of the scene.

7. The method according to claim 5, wherein the metadata of the scene audio signal further comprises second metadata, and determining the metadata of the scene audio signal based on the scene description information of the scene comprises:
using position information of the plurality of microphones as the second metadata when the scene description information comprises the position information of the plurality of microphones, wherein the second metadata is used to determine the distance between two of the plurality of microphones; or
determining the distance between two of the plurality of microphones based on position information of the plurality of microphones when the scene description information comprises the position information of the plurality of microphones; and
using the distance between two of the plurality of microphones as the second metadata.

8. The method according to claim 1, wherein the bitstream comprises a syntax element distanceFactor of the metadata of the scene audio signal and corresponding description information.

9. An encoding method, comprising:
obtaining a scene audio signal; and
encoding the scene audio signal and a first identifier to obtain a bitstream, wherein the first identifier indicates rendering complexity, the rendering complexity is used to determine a number of virtual loudspeakers, a reconstructed audio signal of the scene audio signal is used to generate a virtual loudspeaker signal, and the virtual loudspeaker signal and the number of virtual loudspeakers are used for rendering to obtain a rendered audio signal.

10. The method according to claim 9, wherein the method further comprises:
writing a second identifier into the bitstream, wherein the second identifier indicates whether the bitstream comprises the first identifier.

11. The method according to claim 9, wherein the bitstream comprises a syntax element of the first identifier and corresponding description information; or
wherein the bitstream comprises a syntax element of the second identifier and corresponding description information.

12. The method according to claim 9, wherein the syntax element of the first identifier is complexityLevel.

13. An electronic device, comprising:
a memory that stores program instructions; and
a processor, coupled to the memory, and when the program instructions are executed by the processor, the electronic device is enabled to:
obtain a scene audio signal and metadata of the scene audio signal, wherein the scene audio signal describes a sound field of a sound source in a scene, the scene comprises a plurality of microphones, the metadata of the scene audio signal comprises first metadata, the first metadata is used in combination with a distance between two of the plurality of microphones to determine a virtual loudspeaker radius, the virtual loudspeaker radius and a virtual loudspeaker signal are used for rendering to obtain a rendered audio signal, and the virtual loudspeaker signal is generated based on a reconstructed audio signal of the scene audio signal; and
encode the scene audio signal and the metadata of the scene audio signal to obtain a bitstream.

14. The electronic device according to claim 13, wherein the electronic device is further enabled to:
write a first identifier into the bitstream, wherein the first identifier indicates rendering complexity, and the rendering complexity is used to determine a number of virtual loudspeakers; or
write a second identifier into the bitstream, wherein the second identifier indicates whether the bitstream comprises the metadata of the scene audio signal.

15. The electronic device according to claim 14, wherein
the second identifier further indicates whether the bitstream further comprises the first identifier; or
wherein the electronic device is further enabled to:
write a third identifier into the bitstream, wherein the third identifier indicates whether the bitstream comprises the first identifier.

16. The electronic device according to claim 14, wherein the bitstream comprises a syntax element complexityLevel of the first identifier and corresponding description information; or
wherein the bitstream comprises a syntax element hoaGroupHasLowProfileConfig of the second identifier and corresponding description information.

17. The electronic device according to claim 13, wherein the electronic device is further enabled to:
obtain scene description information of the scene; and
determine the metadata of the scene audio signal based on the scene description information of the scene.

18. The electronic device according to claim 17, wherein the electronic device is further enabled to:
determine the first metadata based on a product of a room critical distance and a preset value when the scene description information comprises the room critical distance of the scene; or
determine a reverberation type of the scene based on an acoustic reverberation parameter of the scene when the scene description information comprises the acoustic reverberation parameter of the scene; and determining the first metadata based on the reverberation type of the scene.

19. The electronic device according to claim 17, wherein the metadata of the scene audio signal further comprises second metadata, and the electronic device is further enabled to:
use position information of the plurality of microphones as the second metadata when the scene description information comprises the position information of the plurality of microphones, wherein the second metadata is used to determine the distance between two of the plurality of microphones; or
determine the distance between two of the plurality of microphones based on position information of the plurality of microphones when the scene description information comprises the position information of the plurality of microphones; and
use the distance between two of the plurality of microphones as the second metadata.

20. The electronic device according to claim 13, wherein the bitstream comprises a syntax element distanceFactor of the metadata of the scene audio signal and corresponding description information.
